(19) United States
(12) Patent Application Publication
(10) Pub. No.: US 2026/0197436 A1
(43) Pub. Date: Jul. 9, 2026

(54) VIDEO CODING METHOD AND DEVICE USING MPM LIST

(71) Applicant: LG Electronics Inc., Seoul (KR)

(72) Inventor: Hyeongmoon JANG, Seoul (KR)

(21) Appl. No.: 18/703,893

(22) PCT Filed: Oct. 27, 2022
(86) PCT No.: PCT/KR2022/016574

§ 371 Date: Apr. 23, 2024

(30) Foreign Application Priority Data
Oct. 28, 2021 (KR) 10-2021-0145239

(51) Int. Cl. H04N 19/103

(52) U.S. Cl. CPC H04N 19/103

(57) ABSTRACT

A video decoding method performed by a decoding device is provided. The method comprises the steps of: configuring a most probable mode (MPM) list including candidate intra prediction modes for a current block; on the basis of the candidate intra prediction modes of the MPM list, deriving an intra prediction mode for the current block; on the basis of the intra prediction mode, creating a predictive sample for the current block; and creating a restorative sample for the current block on the basis of the predictive sample, wherein a specific intra prediction mode consists of one of the candidate intra prediction modes of the MPM list, and the specific intra prediction mode includes at least one of an intra prediction mode derived on the basis of a template based intra mode derivation (TIMD) mode or an intra prediction mode derived on the basis of a decoder side intra mode derivation (DIMD) mode.

### TECHNICAL FIELD

The present disclosure relates to video or image coding technology, for example, to an image coding method and apparatus related to intra prediction using an MPM list.

### BACKGROUND ART

Recently, the demand for high resolution, high quality image/video such as 4K, 8K or more Ultra High Definition (UHD) video/image is increasing in various fields. As the video/image resolution or quality becomes higher, relatively more amount of information or bits are transmitted than for conventional video/image data. Therefore, if video/image data are transmitted via a medium such as an existing wired/wireless broadband line or stored in a legacy storage medium, costs for transmission and storage are readily increased.

Moreover, interests and demand are growing for virtual reality (VR) and artificial reality (AR) contents, and immersive media such as hologram; and broadcasting of images/videos exhibiting image/video characteristics different from those of an actual video/image, such as game images/videos, are also growing.

Therefore, a highly efficient image compression technique is required to effectively compress and transmit, store, or play high resolution, high quality video/image showing various characteristics as described above.

### DISCLOSURE

### Technical Solution

According to an embodiment of the present disclosure, an image decoding method performed by a decoding apparatus is provided. The method includes constructing a Most Probable Mode (MPM) list including candidate intra prediction modes for a current block, deriving an intra prediction mode for the current block based on the candidate intra prediction modes in the MPM list, generating a prediction sample for the current block based on the intra prediction mode, and generating a reconstructed sample for the current block based on the prediction sample, wherein a specific intra prediction mode is constructed as one of the candidate intra prediction modes in the MPM list, wherein the specific intra prediction mode includes at least one of an intra prediction mode derived based on a Template-based Intra Mode Derivation (TIMD) mode or an intra prediction mode derived based on a Decoder Side Intra Mode Derivation (DIMD) mode.

According to another embodiment of the present disclosure, an image encoding method performed by an encoding apparatus is provided. The method includes constructing a Most Probable Mode (MPM) list including candidate intra prediction modes for a current block, deriving an intra prediction mode for the current block based on the candidate intra prediction modes in the MPM list, generating intra prediction mode information for the current block based on the intra prediction mode, and generating a bitstream by encoding image information including the intra prediction mode information, wherein a specific intra prediction mode is constructed as one of the candidate intra prediction modes in the MPM list, wherein the specific intra prediction mode includes at least one of an intra prediction mode derived based on a Template-based Intra Mode Derivation (TIMD) mode or an intra prediction mode derived based on a Decoder Side Intra Mode Derivation (DIMD) mode.

According to another embodiment of the present disclosure, a computer-readable digital storage medium storing a bitstream and/or encoded video/image information generated according to the video/image encoding method disclosed in at least one of the embodiments of the present disclosure is provided.

According to another embodiment of the present disclosure, a transmission method of data for image is provided. The method includes obtaining a bitstream of the image, wherein the bitstream is generated based on constructing a Most Probable Mode (MPM) list including candidate intra prediction modes for a current block, deriving an intra prediction mode for the current block based on the candidate intra prediction modes in the MPM list, generating intra prediction mode information for the current block based on the intra prediction mode, and generating a bitstream by encoding image information including the intra prediction mode information; and transmitting the data comprising the bitstream, wherein a specific intra prediction mode is constructed as one of the candidate intra prediction modes in the MPM list, wherein the specific intra prediction mode includes at least one of an intra prediction mode derived based on a Template-based Intra Mode Derivation (TIMD) mode or an intra prediction mode derived based on a Decoder Side Intra Mode Derivation (DIMD) mode.

### BRIEF DESCRIPTION OF THE DRAWINGS

FIG. 1 schematically illustrates an example of a video/image coding device to which embodiments of the present disclosure are applicable.

FIG. 2 is a schematic diagram illustrating a configuration of a video/image encoding apparatus to which the embodiment(s) of the present disclosure may be applied.

FIG. 3 is a schematic diagram illustrating a configuration of a video/image decoding apparatus to which the embodiment(s) of the present disclosure may be applied.

FIG. 4 exemplarily illustrates a layer structure for a coded video/image.

FIG. 5 schematically illustrates an example of an image encoding method based on intra prediction to which embodiments of the present disclosure may be applied.

FIG. 6 schematically illustrates an intra predictor in an encoding apparatus.

FIG. 7 schematically illustrates an example of an image decoding method based on intra prediction to which embodiments of the present disclosure may be applied.

FIG. 8 schematically illustrates an intra predictor in a decoding apparatus.

FIG. 9 exemplarily illustrates a schematic intra prediction process to which embodiments of the present disclosure may be applied.

FIG. 10 illustrates an example of intra prediction modes to which embodiments of the present disclosure may be applied.

FIG. 11 exemplarily shows a method of configuring a Histogram of Gradiant (HoG) used to derive an intra prediction mode for the DIMD mode.

FIG. 12 exemplarily shows a method of configuring a prediction block by applying DIMD mode.

FIG. 13 exemplarily shows a template used to derive an intra prediction mode for the TIMD mode.

FIG. 14 shows an example of a method for constructing an MPM list in intra prediction.

FIG. 15 shows an example of a method for constructing a secondary MPM list in intra prediction.

FIG. 16 shows an example of a method for deriving a neighboring angular mode based on an intra prediction mode derived at the decoder side according to an embodiment of the present disclosure.

FIGS. 17 and 18 show an example of a method for constructing an MPM list according to an embodiment of the present disclosure.

FIGS. 19 and 20 show an example of a method for constructing a secondary MPM list according to an embodiment of the present disclosure.

FIGS. 21 and 22 schematically show an example of a video/image encoding method and related components according to the embodiment(s) of the present disclosure.

FIGS. 23 and 24 schematically show an example of a video/image decoding method and related components according to the embodiment(s) of the present disclosure.

FIG. 25 illustrates an example of a content streaming system to which embodiments disclosed in the present disclosure may be applied.

### MODE FOR INVENTION

The present disclosure may be modified in various forms, and specific embodiments thereof will be described and illustrated in the drawings. However, the embodiments are not intended for limiting the disclosure. The terms used in the following description are used to merely describe specific embodiments but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be partitioned into plural elements. The embodiments in which the elements are combined and/or partitioned belong to the disclosure without departing from the concept of the disclosure.

In the present description, “A or B” may mean “only A”, “only B” or “both A and B”. In other words, in the present specification, “A or B” may be interpreted as “A and/or B”. For example, “A, B or C” herein means “only A”, “only B”, “only C”, or “any and any combination of A, B and C”.

A slash (/) or a comma (comma) used in the present description may mean “and/or”. For example, “A/B” may mean “A and/or B”. Accordingly, “A/B” may mean “only A”, “only B”, or “both A and B”. For example, “A, B, C” may mean “A, B, or C”.

In the present description, “at least one of A and B” may mean “only A”, “only B”, or “both A and B”. In addition, in the present description, the expression “at least one of A or B” or “at least one of A and/or B” may be interpreted the same as “at least one of A and B”.

In addition, in the present description, “at least one of A, B and C” means “only A”, “only B”, “only C”, or “any combination of A, B and C”. Also, “at least one of A, B or C” or “at least one of A, B and/or C” may mean “at least one of A, B and C”.

In addition, parentheses used in the present description may mean “for example”. Specifically, when “prediction (intra prediction)” is indicated, “intra prediction” may be proposed as an example of “prediction”. In other words, “prediction” in the present description is not limited to “intra prediction”, and “intra prediction” may be proposed as an example of “prediction”. Also, even when “prediction (ie, intra prediction)” is indicated, “intra prediction” may be proposed as an example of “prediction”.

The present disclosure relates to video/image coding. For example, the methods/embodiments disclosed in the present disclosure may be applied to the method disclosed in a versatile video coding (VVC) standard. Further, the methods/exemplary embodiments disclosed in the present disclosure are applicable to a method disclosed in an essential video coding (EVC) standard, an AOMedia Video 1 (AV1) standard, a 2nd generation of audio video coding (AVS2) standard, or a next-generation video/image coding standard (e.g., H.267 or H.268, etc.).

Present disclosure presents various embodiments of video/image coding, and the embodiments may be performed in combination with each other unless otherwise mentioned.

In the present disclosure, video may refer to a series of images over time. Picture generally refers to a unit representing one image in a specific time zone, and a subpicture/slice/tile is a unit constituting part of a picture in coding. The subpicture/slice/tile may include one or more coding tree units (CTUs). One picture may consist of one or more subpictures/slices/tiles. One picture may consist of one or more tile groups. One tile group may include one or more tiles. A brick may represent a rectangular region of CTU rows within a tile in a picture. A tile may be partitioned into multiple bricks, each of which consisting of one or more CTU rows within the tile. A tile that is not partitioned into multiple bricks may be also referred to as a brick. A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture. In addition, a subpicture may represent a rectangular region of one or more slices within a picture. That is, a subpicture contains one or more slices that collectively cover a rectangular region of a picture. A tile is a rectangular region of CTUs within a particular tile column and a particular tile row in a picture. The tile column is a rectangular region of CTUs having a height equal to the height of the picture and a width specified by syntax elements in the picture parameter set. The tile row is a rectangular region of CTUs having a height specified by syntax elements in the picture parameter set and a width equal to the width of the picture. A tile scan is a specific sequential ordering of CTUs partitioning a picture in which the CTUs are ordered consecutively in CTU raster scan in a tile whereas tiles in a picture are ordered consecutively in a raster scan of the tiles of the picture. A slice includes an integer number of bricks of a picture that may be exclusively contained in a single NAL unit. A slice may consist of either a number of complete tiles or only a consecutive sequence of complete bricks of one tile. Tile groups and slices may be used interchangeably in the present disclosure. For example, in the present disclosure, a tile group/tile group header may be called a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. cb, cr) blocks. The unit may be used interchangeably with terms such as block or area in some cases. In a general case, an M×N block may include samples (or sample arrays) or a set (or array) of transform coefficients of M columns and N rows.

In the present description, technical features that are individually described within one drawing may be implemented individually or may be implemented at the same time.

The following drawings were created to explain a specific example of the present description. Since the names of specific devices described in the drawings or the names of specific signals/messages/fields are presented by way of example, the technical features of the present description are not limited to the specific names used in the following drawings.

Hereinafter, embodiments of the present disclosure will be described in detail with reference to the accompanying drawings. In addition, like reference numerals are used to indicate like elements throughout the drawings, and the same descriptions on the like elements will be omitted.

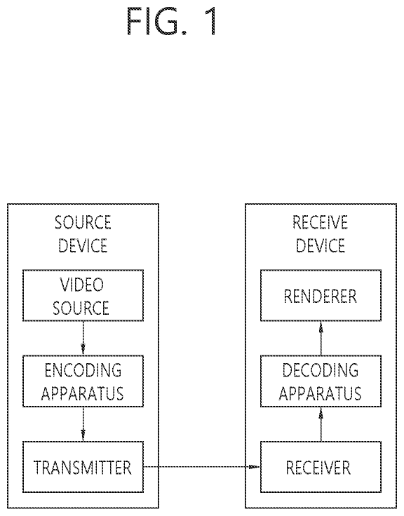

FIG. 1 schematically illustrates an example of a video/image coding device to which embodiments of the present disclosure are applicable.

Referring to FIG. 1, a video/image coding system may include a first device (source device) and a second device (receiving device). The source device may deliver encoded video/image information or data in the form of a file or streaming to the receiving device via a digital storage medium or network.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input image/image. The encoding apparatus may perform a series of procedures such as prediction, transform, and quantization for compression and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

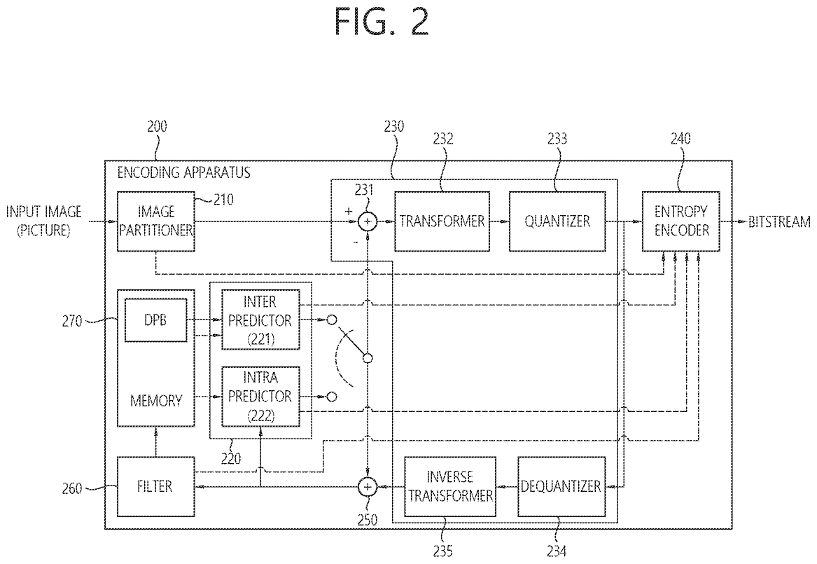

FIG. 2 is a schematic diagram illustrating a configuration of a video/image encoding apparatus to which the embodiment(s) of the present disclosure may be applied. Hereinafter, the encoding apparatus may include an image encoding apparatus and/or a video encoding apparatus.

Referring to FIG. 2, the encoding apparatus 200 includes an image partitioner 210, a predictor 220, a residual processor 230, and an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or a reconstructed block generator. The image partitioner 210, the predictor 220, the residual processor 230, the entropy encoder 240, the adder 250, and the filter 260 may be configured by at least one hardware component (e.g., an encoder chipset or processor) according to an embodiment. In addition, the memory 270 may include a decoded picture buffer (DPB) or may be configured by a digital storage medium. The hardware component may further include the memory 270 as an internal/external component.

The image partitioner 210 may partition an input image (or a picture or a frame) input to the encoding apparatus 200 into one or more processors. For example, the processor may be called a coding unit (CU). In this case, the coding unit may be recursively partitioned according to a quad-tree binary-tree ternary-tree (QTBTTT) structure from a coding tree unit (CTU) or a largest coding unit (LCU). For example, one coding unit may be partitioned into a plurality of coding units of a deeper depth based on a quad tree structure, a binary tree structure, and/or a ternary structure. In this case, for example, the quad tree structure may be applied first and the binary tree structure and/or ternary structure may be applied later. Alternatively, the binary tree structure may be applied first. The coding procedure according to the present disclosure may be performed based on the final coding unit that is no longer partitioned. In this case, the largest coding unit may be used as the final coding unit based on coding efficiency according to image characteristics, or if necessary, the coding unit may be recursively partitioned into coding units of deeper depth and a coding unit having an optimal size may be used as the final coding unit. Here, the coding procedure may include a procedure of prediction, transform, and reconstruction, which will be described later. As another example, the processor may further include a prediction unit (PU) or a transform unit (TU). In this case, the prediction unit and the transform unit may be split or partitioned from the aforementioned final coding unit. The prediction unit may be a unit of sample prediction, and the transform unit may be a unit for deriving a transform coefficient and/or a unit for deriving a residual signal from the transform coefficient.

The unit may be used interchangeably with terms such as block or area in some cases. In a general case, an M×N block may represent a set of samples or transform coefficients composed of M columns and N rows. A sample may generally represent a pixel or a value of a pixel, may represent only a pixel/pixel value of a luma component or represent only a pixel/pixel value of a chroma component. A sample may be used as a term corresponding to one picture (or image) for a pixel or a pel.

In the encoding apparatus 200, a prediction signal (predicted block, prediction sample array) output from the inter predictor 221 or the intra predictor 222 is subtracted from an input image signal (original block, original sample array) to generate a residual signal residual block, residual sample array), and the generated residual signal is transmitted to the transformer 232. In this case, as shown, a part for subtracting a prediction signal (predicted block, prediction sample array) from the input image signal (original block, original sample array) in the encoder 200 may be called a subtractor 231. The predictor may perform prediction on a block to be processed (hereinafter, referred to as a current block) and generate a predicted block including prediction samples for the current block. The predictor may determine whether intra prediction or inter prediction is applied on a current block or CU basis. As described later in the description of each prediction mode, the predictor may generate various information related to prediction, such as prediction mode information, and transmit the generated information to the entropy encoder 240. The information on the prediction may be encoded in the entropy encoder 240 and output in the form of a bitstream.

The intra predictor 222 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 222 may determine the prediction mode applied to the current block by using a prediction mode applied to a neighboring block.

The inter predictor 221 may derive a predicted block for the current block based on a reference block (reference sample array) specified by a motion vector on a reference picture. Here, in order to reduce the amount of motion information transmitted in the inter prediction mode, the motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like, and the reference picture including the temporal neighboring block may be called a collocated picture (colPic). For example, the inter predictor 221 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 221 may use motion information of the neighboring block as motion information of the current block. In the skip mode, unlike the merge mode, the residual signal may not be transmitted. In the case of the motion vector prediction (MVP) mode, the motion vector of the neighboring block may be used as a motion vector predictor and the motion vector of the current block may be indicated by signaling a motion vector difference.

The predictor 220 may generate a prediction signal based on various prediction methods described below. For example, the predictor may not only apply intra prediction or inter prediction to predict one block but also simultaneously apply both intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The prediction signal generated by the predictor (including the inter predictor 221 and/or the intra predictor 222) may be used to generate a reconstructed signal or to generate a residual signal. The transformer 232 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform generated based on a prediction signal generated using all previously reconstructed pixels. In addition, the transform process may be applied to square pixel blocks having the same size or may be applied to blocks having a variable size rather than square.

The quantizer 233 may quantize the transform coefficients and transmit them to the entropy encoder 240 and the entropy encoder 240 may encode the quantized signal (information on the quantized transform coefficients) and output a bitstream. The information on the quantized transform coefficients may be referred to as residual information. The quantizer 233 may rearrange block type quantized transform coefficients into a one-dimensional vector form based on a coefficient scanning order and generate information on the quantized transform coefficients based on the quantized transform coefficients in the one-dimensional vector form. Information on transform coefficients may be generated. The entropy encoder 240 may perform various encoding methods such as, for example, exponential Golomb, context-adaptive variable length coding (CAVLC), context-adaptive binary arithmetic coding (CABAC), and the like. The entropy encoder 240 may encode information necessary for video/image reconstruction other than quantized transform coefficients (e.g., values of syntax elements, etc.) together or separately. Encoded information (e.g., encoded video/image information) may be transmitted or stored in units of NALs (network abstraction layer) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. In the present disclosure, information and/or syntax elements transmitted/signaled from the encoding apparatus to the decoding apparatus may be included in video/picture information. The video/image information may be encoded through the above-described encoding procedure and included in the bitstream. The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 240 and/or a storage unit (not shown) storing the signal may be included as internal/external element of the encoding apparatus 200, and alternatively, the transmitter may be included in the entropy encoder 240.

The quantized transform coefficients output from the quantizer 233 may be used to generate a prediction signal. For example, the residual signal (residual block or residual samples) may be reconstructed by applying dequantization and inverse transform to the quantized transform coefficients through the dequantizer 234 and the inverse transformer 235. The adder 250 adds the reconstructed residual signal to the prediction signal output from the inter predictor 221 or the intra predictor 222 to generate a reconstructed signal (reconstructed picture, reconstructed block, reconstructed sample array). If there is no residual for the block to be processed, such as a case where the skip mode is applied, the predicted block may be used as the reconstructed block. The adder 250 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) may be applied during picture encoding and/or reconstruction.

The filter 260 may improve subjective/objective image quality by applying filtering to the reconstructed signal. For example, the filter 260 may generate a modified reconstructed picture by applying various filtering methods to the reconstructed picture and store the modified reconstructed picture in the memory 270, specifically, a DPB of the memory 270. The various filtering methods may include, for example, deblocking filtering, a sample adaptive offset, an adaptive loop filter, a bilateral filter, and the like. The filter 260 may generate various information related to the filtering and transmit the generated information to the entropy encoder 240 as described later in the description of each filtering method. The information related to the filtering may be encoded by the entropy encoder 240 and output in the form of a bitstream.

The modified reconstructed picture transmitted to the memory 270 may be used as the reference picture in the inter predictor 221. When the inter prediction is applied through the encoding apparatus, prediction mismatch between the encoding apparatus 200 and the decoding apparatus 300 may be avoided and encoding efficiency may be improved.

The DPB of the memory 270 may store the modified reconstructed picture for use as a reference picture in the inter predictor 221. The memory 270 may store the motion information of the block from which the motion information in the current picture is derived (or encoded) and/or the motion information of the blocks in the picture that have already been reconstructed. The stored motion information may be transmitted to the inter predictor 221 and used as the motion information of the spatial neighboring block or the motion information of the temporal neighboring block. The memory 270 may store reconstructed samples of reconstructed blocks in the current picture and may transfer the reconstructed samples to the intra predictor 222.

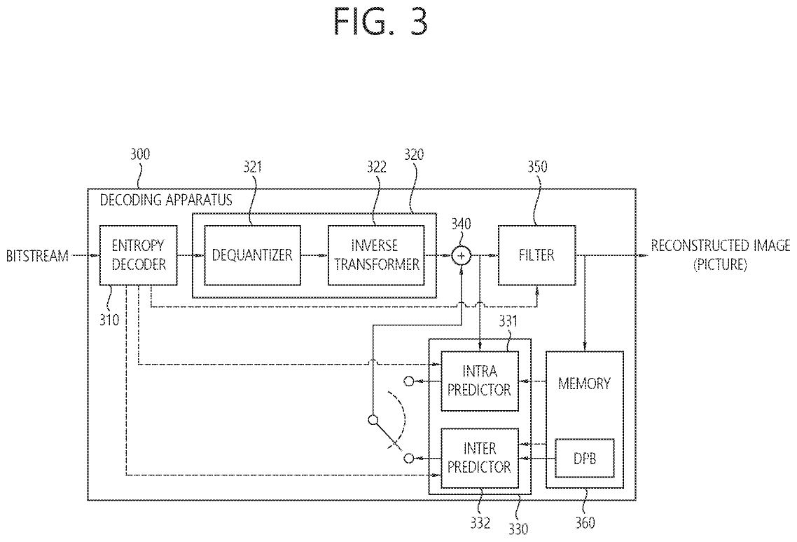

FIG. 3 is a schematic diagram illustrating a configuration of a video/image decoding apparatus to which the embodiment(s) of the present disclosure may be applied. Hereinafter, the decoding apparatus may include an image decoding apparatus and/or a video decoding apparatus.

Referring to FIG. 3, the decoding apparatus 300 may include an entropy decoder 310, a residual processor 320, a predictor 330, an adder 340, a filter 350, a memory 360. The predictor 330 may include an intra predictor 331 and an inter predictor 332. The residual processor 320 may include a dequantizer 321 and an inverse transformer 322. The entropy decoder 310, the residual processor 320, the predictor 330, the adder 340, and the filter 350 may be configured by a hardware component (e.g., A decoder chipset or a processor) according to an embodiment. In addition, the memory 360 may include a decoded picture buffer (DPB) or may be configured by a digital storage medium. The hardware component may further include the memory 360 as an internal/external component.

When a bitstream including video/image information is input, the decoding apparatus 300 may reconstruct an image corresponding to a process in which the video/image information is processed in the encoding apparatus of FIG. 2. For example, the decoding apparatus 300 may derive units/blocks based on block partition related information obtained from the bitstream. The decoding apparatus 300 may perform decoding using a processor applied in the encoding apparatus. Thus, the processor of decoding may be a coding unit, for example, and the coding unit may be partitioned according to a quad tree structure, binary tree structure and/or ternary tree structure from the coding tree unit or the largest coding unit. One or more transform units may be derived from the coding unit. The reconstructed image signal decoded and output through the decoding apparatus 300 may be reproduced through a reproducing apparatus.

The decoding apparatus 300 may receive a signal output from the encoding apparatus of FIG. 2 in the form of a bitstream, and the received signal may be decoded through the entropy decoder 310. For example, the entropy decoder 310 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The decoding apparatus may further decode picture based on the information on the parameter set and/or the general constraint information. Signaled/received information and/or syntax elements described later in the present disclosure may be decoded may decode the decoding procedure and obtained from the bitstream. For example, the entropy decoder 310 decodes the information in the bitstream based on a coding method such as exponential Golomb coding, CAVLC, or CABAC, and output syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a decoding target block or information of a symbol/bin decoded in a previous stage, and perform an arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 310 may be provided to the predictor (the inter predictor 332 and the intra predictor 331), and the residual value on which the entropy decoding was performed in the entropy decoder 310, that is, the quantized transform coefficients and related parameter information, may be input to the residual processor 320. The residual processor 320 may derive the residual signal (the residual block, the residual samples, the residual sample array). In addition, information on filtering among information decoded by the entropy decoder 310 may be provided to the filter 350. Meanwhile, a receiver (not shown) for receiving a signal output from the encoding apparatus may be further configured as an internal/external element of the decoding apparatus 300, or the receiver may be a component of the entropy decoder 310. Meanwhile, the decoding apparatus according to the present disclosure may be referred to as a video/image/picture decoding apparatus, and the decoding apparatus may be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients and output the transform coefficients. The dequantizer 321 may rearrange the quantized transform coefficients in the form of a two-dimensional block form. In this case, the rearrangement may be performed based on the coefficient scanning order performed in the encoding apparatus. The dequantizer 321 may perform dequantization on the quantized transform coefficients by using a quantization parameter (e.g., quantization step size information) and obtain transform coefficients.

The inverse transformer 322 inversely transforms the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 310 and may determine a specific intra/inter prediction mode.

The predictor 320 may generate a prediction signal based on various prediction methods described below. For example, the predictor may not only apply intra prediction or inter prediction to predict one block but also simultaneously apply intra prediction and inter prediction. This may be called combined inter and intra prediction (CIIP). In addition, the predictor may be based on an intra block copy (IBC) prediction mode or a palette mode for prediction of a block. The IBC prediction mode or palette mode may be used for content image/video coding of a game or the like, for example, screen content coding (SCC). The IBC basically performs prediction in the current picture but may be performed similarly to inter prediction in that a reference block is derived in the current picture. That is, the IBC may use at least one of the inter prediction techniques described in the present disclosure. The palette mode may be considered as an example of intra coding or intra prediction. When the palette mode is applied, a sample value within a picture may be signaled based on information on the palette table and the palette index.

The intra predictor 331 may predict the current block by referring to the samples in the current picture. The referred samples may be located in the neighborhood of the current block or may be located apart according to the prediction mode. In the intra prediction, prediction modes may include a plurality of non-directional modes and a plurality of directional modes. The intra predictor 331 may determine the prediction mode applied to the current block by using a prediction mode applied to a neighboring block.

The inter predictor 332 may derive a predicted block for the current block based on a reference block (reference sample array) specified by a motion vector on a reference picture. In this case, in order to reduce the amount of motion information transmitted in the inter prediction mode, motion information may be predicted in units of blocks, sub-blocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 332 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 340 may generate a reconstructed signal (reconstructed picture, reconstructed block, reconstructed sample array) by adding the obtained residual signal to the prediction signal (predicted block, predicted sample array) output from the predictor (including the inter predictor 332 and/or the intra predictor 331). If there is no residual for the block to be processed, such as when the skip mode is applied, the predicted block may be used as the reconstructed block.

The adder 340 may be called reconstructor or a reconstructed block generator. The generated reconstructed signal may be used for intra prediction of a next block to be processed in the current picture, may be output through filtering as described below, or may be used for inter prediction of a next picture.

Meanwhile, luma mapping with chroma scaling (LMCS) may be applied in the picture decoding process.

The filter 350 may improve subjective/objective image quality by applying filtering to the reconstructed signal. For example, the filter 350 may generate a modified reconstructed picture by applying various filtering methods to the reconstructed picture and store the modified reconstructed picture in the memory 360, specifically, a DPB of the memory 360. The various filtering methods may include, for example, deblocking filtering, a sample adaptive offset, an adaptive loop filter, a bilateral filter, and the like.

The (modified) reconstructed picture stored in the DPB of the memory 360 may be used as a reference picture in the inter predictor 332. The memory 360 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 360 may store reconstructed samples of reconstructed blocks in the current picture and transfer the reconstructed samples to the intra predictor 331.

In the present disclosure, the embodiments described in the filter 260, the inter predictor 221, and the intra predictor 222 of the encoding apparatus 200 may be the same as or respectively applied to correspond to the filter 350, the inter predictor 332, and the intra predictor 331 of the decoding apparatus 300. The same may also apply to the unit 332 and the intra predictor 331.

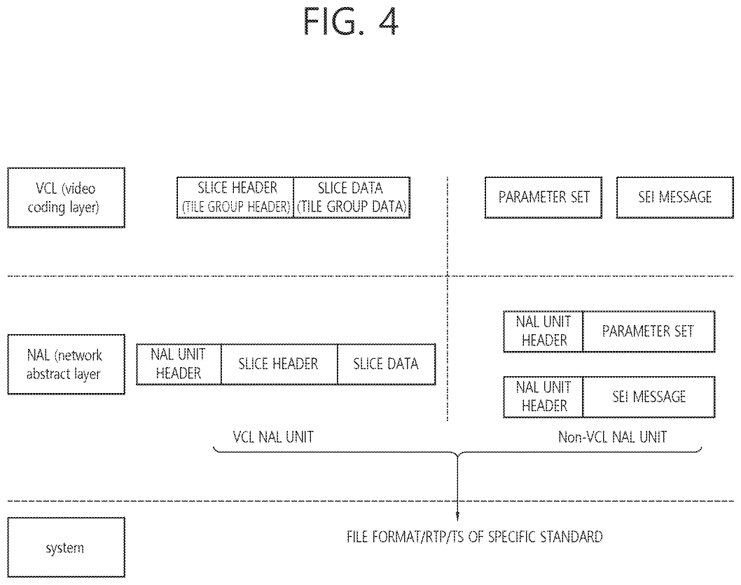

FIG. 4 exemplarily illustrates a layer structure for a coded video/image.

Referring to FIG. 4, a coded video/image may be divided into a video coding layer (VCL) that performs decoding processing of a video/image and handles the decoding processing, a lower system that transmits and stores coded information, and a network abstraction layer (NAL) which exists between the VCL and the lower system, and serves to perform a network adaptation function.

For example, VCL data including compressed image data (slice data), or a picture parameter set (PPS), a sequence parameter set (SPS), or a video parameter set (VPS), or a parameter set including a supplemental enhancement information (SEI) message additionally required in an image decoding process may be generated, in the VCL.

For example, in the NAL, header information (NAL unit data) is added to a raw byte sequence payload (RSRP) generated in the VCL to generate the NAL unit. In this case, the slice data, the parameter set, the SEI message, etc., generated in the VCL may be referred to, for the RBSP. The NAL unit header may include NAL unit type information specified according to RSRP data included in the corresponding NAL unit.

For example, as illustrated in FIG. 4, the NAL unit may be classified into a VCL NAL unit and a non-VCL NAL unit according to the RSRP generated in the VCL. The VCL NAL unit may mean a NAL unit including information (slice data) on the information, and the non-VCL NAL unit may mean a NAL unit including information (parameter set or SEI message) required to decode the image.

The VCL NA unit and the non-VCL NAL unit may be transmitted through a network while header information is added according to a data standard of a sub system. For example, the NAL unit may be converted into a data format of a predetermined standard such as an H.266/VVC file format, a real-time transport protocol (RTP), a transport stream (TS), etc., and transported through various networks.

Further, as described above, in respect to the NAL unit, a NAL unit type may be specified according to an RBSP data structure included in the corresponding NAL unit, and information on the NAL unit type may be stored in a NAL unit header and signaled.

For example, the NAL unit may be classified into a VCL NAL unit type and a non-VCL NAL unit type according to whether the NAL unit includes information (slice data) on the image. Further, the VCL NAL unit type may be classified according to a property and a type of picture included in the VCL NAL unit and the non-VCL NAL unit may be classified according to the type of parameter set.

The following is an example of the NAL unit type specified according to the type of parameter set included in the non-VCL NAL unit type.
Adaptation Parameter Set (APS) NAL unit: Type for the NAL unit including the APS
Decoding Parameter Set (DPS) NAL unit: Type for the NAL unit including the DPS
Video Parameter Set (VPS) NAL unit: Type for the NAL unit including the VPS
Sequence Parameter Set (SPS) NAL unit: Type for the NAL unit including the SPS
Picture Parameter Set (PPS) NAL unit: Type for the NAL unit including the PPS
Picture header (PH) NAL unit: Type for the NAL unit including the PH

The above-described NAL unit types may have syntax information for the NAL unit type and the syntax information may be stored in the NAL unit header and signaled. For example, the syntax information may be nal_unit_type and the NAL unit type may be specified as a value of nal_unit_type.

Meanwhile, one picture may include a plurality of slices, and the slice may include a slice header and slice data. In this case, one picture header may be added for the plurality of slices (a set of the slice header and the slice data). The picture header (picture header syntax) may include information/parameters which may be commonly applied to a picture. The slice header (slice header syntax) may include information/parameters which may be commonly applied to a slice. APS (ASP syntax) or PPS (PPS syntax) may include information/parameters which may be commonly applied to one or more slices or pictures. SPS (SPS syntax) may include information/parameters which may be commonly applied to one or more sequences. VPS (VPS syntax) may include information/parameters which may be commonly applied to a plurality of layers. DPS (DPS syntax) may include information/parameters which may be commonly applied to an overall image. The DPS may include information/parameter related to concatenation of a coded video sequence (CVS).

In the present disclosure, the image/video information encoded from the encoding apparatus to the decoding apparatus and signaled in the form of the bitstream may include intra-picture partitioning related information, intra/inter prediction information, interlayer prediction related information, residual information, and in-loop filtering information, and may include information included in the APS, information included in the PPS, information included in the SPS, information included in the VPS, and/or information included in the DPS. Further, the image/video information may further include information of the NAL unit header.

Meanwhile, as described above, in performing video coding, prediction is performed to increase compression efficiency. A predicted block including prediction samples for the current block, that is, the coding target block, may be generated through the prediction. Here, the predicted block includes the prediction samples in a spatial domain (or pixel domain). The predicted block is identically derived in the encoding apparatus and the decoding apparatus. The encoding apparatus may enhance image coding efficiency by signaling, to the decoding apparatus, information on a residual (residual information) between the original block not an original sample value itself of the original block and the predicted block. The decoding apparatus may derive a residual block including residual samples based on the residual information, may generate a reconstructed including reconstructed samples by adding the residual block and the predicted block, and may generate a reconstructed picture including the reconstructed blocks.

The residual information may be generated through a transform and quantization procedure. For example, the encoding apparatus may derive the residual block between the original block and the predicted block, may derive transform coefficients by performing a transform procedure on the residual samples (residual sample array) included in the residual block, may derive quantized transform coefficients by performing a quantization procedure on the transform coefficients, and may signal related residual information to the decoding apparatus (through a bitstream). Here, the residual information may include information, such as value information, location information, transform scheme, transform kernel, and quantization parameter of the quantized transform coefficients. The decoding apparatus may perform a dequantization/inverse transform procedure based on the residual information, and may derive residual samples (or residual block). The decoding apparatus may generate a reconstructed picture based on the predicted block and the residual block. Furthermore, the encoding apparatus may derive a residual block by dequantizing/inverse-transforming the quantized transform coefficients for reference to the inter prediction of a subsequent picture, and may generate a reconstructed picture.

In the present disclosure, at least one of the quantization/the dequantization and/or the transform/the inverse transform may be omitted. If the quantization/dequantization is omitted, the quantized transform coefficient may be referred to as a transform coefficient. If the transform/the inverse transform are omitted, the transform coefficient may also be referred to as a coefficient or a residual coefficient, or for unity of expression, also be still referred to as the transform coefficient. In addition, whether or not the transform/inverse transform is omitted may be signaled based on transform_skip_flag.

In the present disclosure, the quantized transform coefficient and the transform coefficient may be referred to as a transform coefficient and a scaled transform coefficient, respectively. In this case, the residual information may include information about the transform coefficient(s), and the information about the transform coefficient(s) may be signaled through a residual coding syntax. The transform coefficients may be derived based on the residual information (or the information about the transform coefficient(s)), and the scaled transform coefficients may be derived through the inverse transform (scaling) for the transform coefficients. The residual samples may be derived based on the inverse transform (transform) for the scaled transform coefficients. This may be likewise applied to/expressed in other parts of the present disclosure.

Meanwhile, when intra prediction is performed, correlation between samples may be used and a difference between an original block and a prediction block, that is, a residual may be obtained. The above-described transform and quantization may be applied to the residual, through this, spatial redundancy may be removed. Hereinafter, an encoding method and a decoding method using intra prediction will be described in detail.

Intra prediction refers to prediction that generates prediction samples for a current block based on reference samples outside the current block in a picture including the current block (hereinafter referred to as the current picture). Here, reference samples outside the current block may refer to samples positioned around the current block. When intra prediction is applied to the current block, neighboring reference samples to be used for intra prediction of the current block may be derived.

For example, when the size (width×height) of the current block is nW×nH, the neighboring reference samples of the current block may include a total of 2×nH samples including samples adjacent to the left boundary of the current block and samples neighboring to the bottom-left of the current block, a total of 2×nW samples including samples adjacent to the top boundary and samples neighboring to the top-right current block, and 1 sample adjacent to the top-left of the current block. Alternatively, the neighboring reference samples of the current block may include samples top neighboring samples in a plurality of columns and left neighboring samples in a plurality of rows. In addition, the neighboring reference samples of the current block may include a total of nH samples adjacent to the right boundary of the current block of size nW×nH, a total of nW samples adjacent to the bottom boundary of the current block of size nW×nH, and 1 sample neighboring to the bottom-right of the current block of size nW×nH.

However, some of the neighboring reference samples of the current block may not be decoded yet or may not be available. In this case, the decoding apparatus may configure neighboring reference samples to be used for prediction by substituting unavailable samples with available samples. Alternatively, neighboring reference samples to be used for prediction may be configured through interpolation of available samples.

When the neighboring reference samples are derived, (i) a prediction sample may be derived based on the average or interpolation of the neighboring reference samples of the current block, and (ii) a prediction sample may be derived based on a reference sample existing in a specific (prediction) direction with respect to the prediction sample among neighboring reference samples of the current block. Case (i) may be applied when the intra prediction mode is a non-directional mode or non-angular mode, and case (ii) may be applied when the intra prediction mode is a directional mode or an angular mode.

In addition, through interpolation between a first neighboring sample located in a prediction direction of the intra prediction mode of the current block based on the prediction sample of the current block among the neighboring reference samples and a second neighboring sample located in the opposite direction of the prediction direction, the prediction sample may be generated. The above case may be called linear interpolation intra prediction (LIP). Also, chroma prediction samples may be generated based on luma samples using a linear model. This case can be called LM mode.

In addition, a temporary prediction sample of the current block may be derived based on filtered neighboring reference samples, and at least one reference sample derived according to the intra prediction mode among the existing neighboring reference samples, that is, unfiltered neighboring reference samples, and the temporary prediction sample may be weighted-summed to derive the prediction sample of the current block. The above case may be referred to as position dependent intra prediction (PDPC).

A reference sample line having the highest prediction accuracy among the neighboring multi-reference sample lines of the current block may be selected to derive the prediction sample by using the reference sample located in the prediction direction on the corresponding line, and then the reference sample line used herein may be indicated (signaled) to the decoding apparatus, thereby performing intra-prediction encoding. The above case may be referred to as multi-reference line (MRL) intra prediction or MRL based intra prediction.

In addition, intra prediction may be performed based on the same intra prediction mode by dividing the current block into vertical or horizontal subpartitions, and neighboring reference samples may be derived and used in the subpartition unit. That is, in this case, the intra prediction mode for the current block is equally applied to the subpartitions, and the intra prediction performance may be improved in some cases by deriving and using the neighboring reference samples in the subpartition unit. Such a prediction method may be called intra sub-partitions (ISP) or ISP based intra prediction.

The above-described intra prediction methods may be called an intra prediction type separately from the intra prediction mode. The intra prediction type may be called in various terms such as an intra prediction technique or an additional intra prediction mode. For example, the intra prediction type (or additional intra prediction mode) may include at least one of the above-described LIP, PDPC, MRL, or ISP. A general intra prediction method except for the specific intra prediction type such as LIP, PDPC, MRL, or ISP may be called a normal intra prediction type. The normal intra prediction type may be generally applied when the specific intra prediction type is not applied, and prediction may be performed based on the intra prediction mode described above. Meanwhile, post-filtering may be performed on the predicted sample derived as needed.

Meanwhile, in addition to the above-described intra prediction types, matrix based intra prediction (MIP) may be used as one method for intra prediction. MIP may be referred to as affine linear weighted intra prediction (ALWIP) or matrix weighted intra prediction (MIP).

If the MIP is applied to the current block, i) using neighboring reference samples on which an averaging process has been performed, ii) matrix-vector-multiplication process is performed, and iii) a horizontal/vertical interpolation process may be further performed to derive prediction samples for the current block as necessary. The intra prediction modes used for the MIP may be configured to be different from the intra prediction modes used in the LIP, PDPC, MRL, ISP intra prediction or normal intra prediction.

The intra prediction mode for MIP may be called “affine linear weighted intra prediction mode” or matrix-based intra prediction mode. For example, a matrix and an offset used in matrix vector multiplication may be set differently according to the intra prediction mode for the MIP. Here, the matrix may be referred to as an (affine) weight matrix, and the offset may be referred to as an (affine) offset vector or an (affine) bias vector. In this document, intra prediction mode for MIP may be called MIP intra prediction mode, linear weighted intra prediction mode, matrix weighted intra prediction mode, or matrix based intra prediction mode. A specific MIP method will be described later.

The following drawings are prepared to explain specific examples of this document. Since the names of specific devices or specific terms or names (eg, names of syntaxes) described in the drawings are provided as examples, the technical features of this document are not limited to the specific names used in the drawings below.

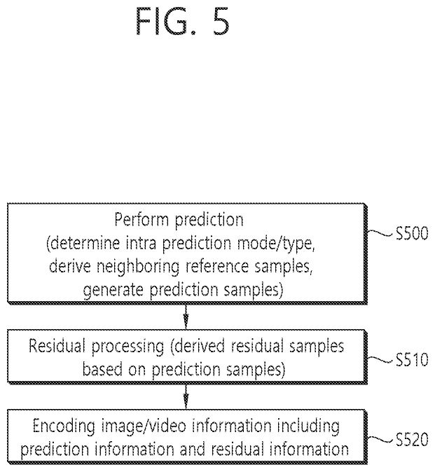

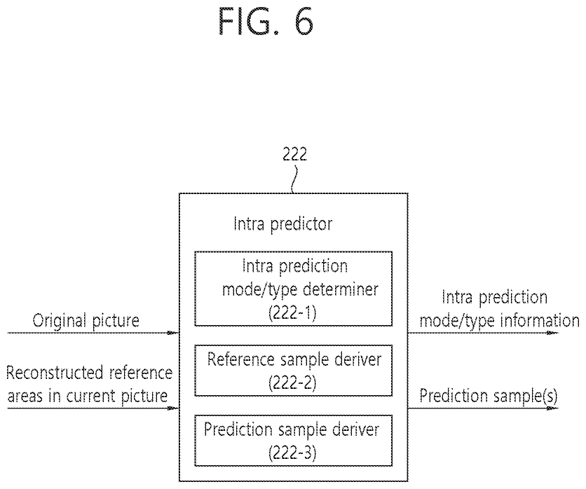

FIG. 5 schematically illustrates an example of an image encoding method based on intra prediction to which embodiments of the present disclosure may be applied, and FIG. 6 schematically illustrates an intra predictor in an encoding apparatus. The intra predictor in the encoding apparatus of FIG. 6 may be applied to the same or corresponding to the intra predictor 222 of the encoding apparatus 200 of FIG. 2 described above.

Referring to FIGS. 5 and 6, S500 may be performed by the intra predictor 222 of the encoding apparatus, and S510 may be performed by the residual processor 230 of the encoding apparatus. Specifically, S510 may be performed by the subtractor 231 of the encoding apparatus. In S520, prediction information may be derived by the intra predictor 222 and encoded by the entropy encoder 240. In S520, residual information may be derived by the residual processor 230 and encoded by the entropy encoder 240. The residual information is information about residual samples. The residual information may include information about quantized transform coefficients of residual samples. As described above, the residual samples may be derived as transform coefficients through a transformer of the encoding apparatus, and the transform coefficients may be derived as quantized transform coefficients through a quantizer. Information about quantized transform coefficients may be encoded in the entropy encoder 240 through a residual coding process.

The encoding apparatus performs intra prediction on the current block (S500). The encoding apparatus may derive an intra prediction mode/type for the current block, derive neighboring reference samples of the current block, and generate prediction samples within the current block based on the intra prediction mode/type and the neighboring reference samples. Here, intra prediction mode/type determination, neighboring reference samples derivation, and prediction samples generation process may be performed simultaneously, or one process may be performed prior to another process.

For example, the intra predictor 222 of the encoding apparatus may include an intra prediction mode/type determiner 222-1, a reference sample deriver 222-2, and a prediction sample deriver 222-3. The intra prediction mode/type determiner 222-1 determines the intra prediction mode/type for the current block, the reference sample deriver 222-2 derives neighboring reference samples of the current block, and the prediction sample deriver 222-3 may derive prediction samples of the current block. Meanwhile, although not shown, when a prediction sample filtering process is performed, the intra predicter 222 may further include a prediction sample filtering (not shown). The encoding apparatus may determine a mode/type applied to the current block from among a plurality of intra prediction modes/types. The encoding apparatus may compare RD costs for intra prediction modes/types and determine an optimal intra prediction mode/type for the current block.

As described above, the encoding apparatus may perform a prediction sample filtering process. Prediction sample filtering may be referred to as post filtering. Some or all of the prediction samples may be filtered through the prediction sample filtering process. In some cases, the prediction sample filtering process may be omitted.

The encoding apparatus generates residual samples for the current block based on the (filtered) prediction samples (S510). The encoding apparatus may compare prediction samples from original samples of the current block based on phase and derive residual samples.

The encoding apparatus may encode image information including intra prediction information (prediction information) and residual information about residual samples (S520). Prediction information may include intra prediction mode information and intra prediction type information. Residual information may include residual coding syntax. The encoding apparatus may transform/quantize the residual samples to derive quantized transform coefficients. The residual information may include information about the quantized transform coefficients.

The encoding apparatus may output encoded image information in the form of a bitstream. The output bitstream may be delivered to a decoding apparatus through a storage medium or network.

As described above, the encoding apparatus may generate a reconstructed picture (including reconstructed samples and a reconstructed block). To this end, the encoding apparatus may derive (modified) residual samples by dequantizing/inverse transforming the quantized transform coefficients again. The reason for performing dequantization/inverse transformation after transforming/quantizing the residual samples in this way is to derive the same residual samples as the residual samples derived from the decoding apparatus as described above. The encoding apparatus may generate a reconstructed block including reconstructed samples for the current block based on prediction samples and (modified) residual samples. A reconstructed picture for a current picture may be generated based on the reconstructed block. As described above, an in-loop filtering process or the like may be further applied to the reconstructed picture.

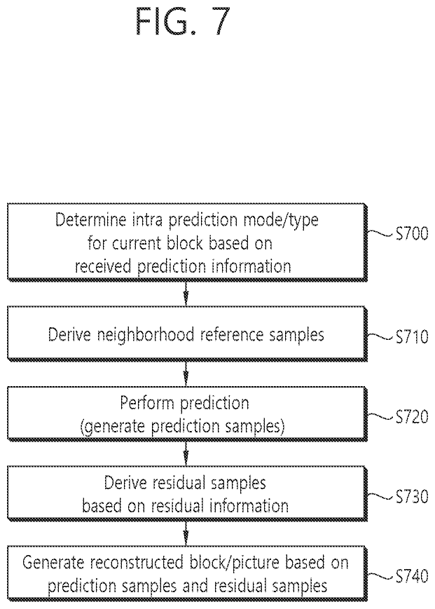

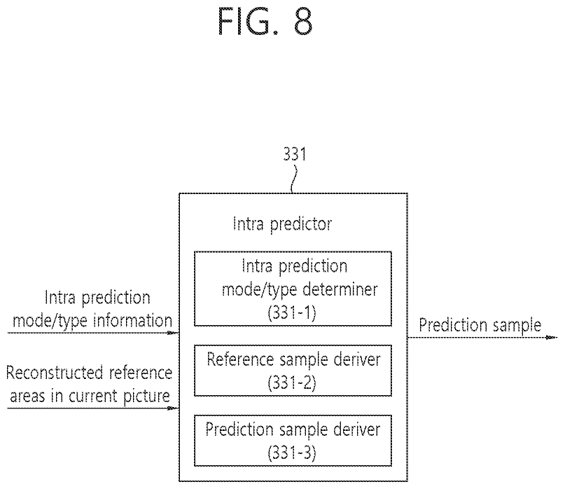

FIG. 7 schematically illustrates an example of an image decoding method based on intra prediction to which embodiments of the present disclosure may be applied, and FIG. 8 schematically illustrates an intra predictor in a decoding apparatus. The intra predictor in the decoding apparatus of FIG. 8 may be applied to the same or corresponding to the above-described intra predictor 331 of the decoding apparatus 300 of FIG. 2.

Referring to FIGS. 7 and 8, the decoding apparatus may perform an operation corresponding to the operation performed by the above-described encoding apparatus. S700 to S720 may be performed by the intra predictor 331 of the decoding apparatus, and the prediction information of S700 and the residual information of S730 may be obtained from the bitstream by the entropy decoder 310 of the decoding apparatus. The residual processor 320 of the decoding apparatus may derive residual samples for the current block based on the residual information. Specifically, the dequantizer 321 of the residual processor 320 derives transform coefficients by performing dequantization based on the quantized transform coefficients derived based on the residual information, and the inverse transformer of the residual processor 322 may derive residual samples for the current block by performing an inverse transform on the transform coefficients. S740 may be performed by the adder 340 or a reconstructor of the decoding apparatus.

The decoding apparatus may derive an intra prediction mode/type for the current block based on the received prediction information (intra prediction mode/type information) (S700). The decoding apparatus may derive neighboring reference samples of the current block (S710). The decoding apparatus generates prediction samples within the current block based on the intra prediction mode/type and neighboring reference samples (S720). In this case, the decoding apparatus may perform a prediction sample filtering process. Prediction sample filtering may be referred to as post filtering. Some or all of the prediction samples may be filtered through the prediction sample filtering process. In some cases, the prediction sample filtering process may be omitted.

The decoding apparatus generates residual samples for the current block based on the received residual information (S730). The decoding apparatus may generate reconstructed samples for the current block based on the prediction samples and residual samples, and derive a reconstructed block including the reconstructed samples (S740). A reconstructed picture for a current picture may be generated based on the reconstructed block. As described above, an in-loop filtering process or the like may be further applied to the reconstructed picture.

Here, the intra predictor 331 of the decoding apparatus may include an intra prediction mode/type determiner 231-1, a reference sample deriver 331-2, and a prediction sample deriver 231-3. The intra prediction mode/type determiner 331-1 determines the intra prediction mode/type of the current block based on the intra prediction mode/type information obtained from the entropy decoder 310, and the reference sample deriver 331-2) may derive neighboring reference samples of the current block, and the prediction sample deriver 331-3 may derive prediction samples of the current block. Meanwhile, although not shown, when the above-described prediction sample filtering process is performed, the intra prediction unit 331 may further include a prediction sample filter (not shown).

The intra prediction mode information may include, for example, flag information (ex. intra_luma_mpm_flag) indicating whether the most probable mode (MPM) or remaining mode is applied to the current block. In this case, when MPM is applied to the current block, the prediction mode information may further include index information (ex. intra_luma_mpm_idx) indicating one of intra prediction mode candidates (MPM candidates). Intra prediction mode candidates (MPM candidates) may be composed of an MPM candidate list or an MPM list. In addition, when MPM is not applied to the current block, the intra prediction mode information may further include remaining mode information (ex. intra_luma_mpm_remainder) indicating one of intra prediction modes other than intra prediction mode candidates (MPM candidates). there is. The decoding apparatus may determine the intra prediction mode of the current block based on the intra prediction mode information.

In addition, intra prediction type information may be implemented in various forms. For example, intra prediction type information may include intra prediction type index information indicating one of intra prediction types. As another example, the intra prediction type information includes at least one of reference sample line information (ex. intra_luma_ref_idx) indicating whether the MRL is applied to the current block and, if the MRL is applicable, whether a reference sample line is used or not, ISP flag information (ex. intra_subpartitions_mode_flag) indicating whether the ISP is applied to the current block, ISP type information (ex. intra_subpartitions_split_flag) in which subpartitions indicates a partition type when the ISP is applied, flag information indicating whether PDCP is applied, or flag information whether LIP is applied. In addition, the intra prediction type information may include a MIP flag information indicating whether MIP is applied to the current block.

The aforementioned intra prediction mode information and/or intra prediction type information may be encoded/decoded through the coding method described in this document. For example, the aforementioned intra prediction mode information and/or intra prediction type information may be encoded/decoded through entropy coding (eg. CABAC, CAVLC) coding based on truncated (rice) binary code.

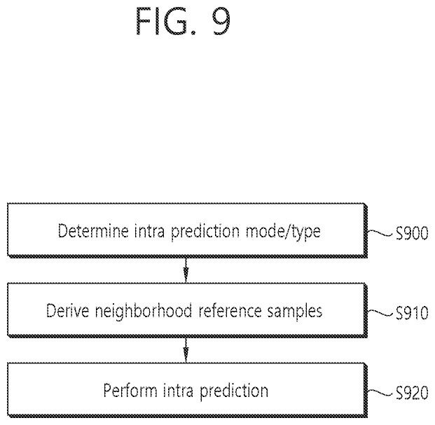

FIG. 9 exemplarily illustrates a schematic intra prediction process to which embodiments of the present disclosure may be applied.

Referring to FIG. 9, as described above, the intra prediction process may include determining an intra prediction mode/type, deriving neighboring reference samples, and performing intra prediction (generating prediction samples). The intra prediction process may be performed in the encoding apparatus and the decoding apparatus as described above. A coding apparatus in this document may include an encoding apparatus and/or a decoding apparatus.

The coding apparatus may determine an intra prediction mode/type (S900).

The encoding apparatus may determine an intra prediction mode/type applied to the current block among various intra prediction modes/types described above and generate prediction-related information. The prediction related information may include intra prediction mode information indicating an intra prediction mode applied to the current block and/or intra prediction type information indicating an intra prediction type applied to the current block. The decoding apparatus may determine an intra prediction mode/type applied to the current block based on the prediction related information.

As described above, the intra prediction mode information may include at least one of MPM flag information, non-planar flag information, MPM index information, and/or remaining mode (MPM reminder) information. As described above, the intra prediction type information includes reference sample line (MRL index) information (ex. intra_luma_ref_idx), ISP flag information (ex. intra_subpartitions_mode_flag), ISP type information (ex. intra_subpartitions_split_flag), and flag information indicating whether PDCP is applied or not, flag information indicating whether LIP is applied and/or MIP flag information.

For example, when intra prediction is applied, the intra prediction mode applied to the current block may be determined using the intra prediction modes of neighboring blocks. For example, the coding apparatus may select one of MPM candidates in a most probable mode (MPM) list derived based on an intra prediction mode and/or additional candidate modes of a neighboring block (eg, a left and/or upper neighboring block) of a current block, based on the received MPM index, or may select one of the remaining intra prediction modes not included in the MPM candidates (and planar mode) based on MPM reminder information (remaining intra prediction mode information). The MPM list may be configured to include or not include a planar mode as a candidate. For example, if the mpm list includes the planar mode as a candidate, the MPM list may have 6 candidates, and if the MPM list does not include the planar mode as a candidate, the mpm list may have 5 candidates. When the MPM list does not include a planar mode as a candidate, a non-planar flag (ex. intra_luma_not_planar_flag) indicating whether the intra prediction mode of the current block is not a planar mode may be signaled. For example, the MPM flag may be signaled first, and the MPM index and non-planar flag may be signaled when the value of the MPM flag is 1. Also, the MPM index may be signaled when the value of the non-planar flag is 1. Here, the reason why the MPM list is configured not to include the planar mode as a candidate is that the planar mode is not MPM, rather than that the planar mode is always considered as the MPM, so a not planar flag is first signaled. This is to check whether it is in planar mode first. For example, whether the intra prediction mode applied to the current block is among MPM candidates (and planar mode) or remaining mode may be indicated based on an MPM flag (ex. intra_luma_mpm_flag). A value of 1 of the MPM flag may indicate that the intra prediction mode for the current block is within MPM candidates (and planar mode), and a value of 0 of the MPM flag may indicate that the intra prediction mode for the current block is not within MPM candidates (and planar mode). The not planar flag (ex. intra_luma_not_planar_flag) value 0 may indicate that the intra prediction mode of the current block is the planar mode, and the not planar flag value 1 may indicate that the intra prediction mode of the current block is not the planar mode. The MPM index may be signaled in the form of an mpm_idx or intra_luma_mpm_idx element, and the remaining intra prediction mode information may be signaled in the form of a rem_intra_luma_pred_mode or intra_luma_mpm_remainder syntax element. For example, the remaining intra prediction mode information may indicate one of all intra prediction modes by indexing remaining intra prediction modes not included in the MPM candidates (and planar mode) in order of prediction mode numbers. The intra prediction mode may be an intra prediction mode for a luma component (sample). Hereinafter, the intra prediction mode information includes at least one of the MPM flag (ex. intra_luma_mpm_flag), the not planar flag (ex. intra_luma_not_planar_flag), the MPM index (ex. mpm_idx or intra_luma_mpm_idx), and the remaining intra prediction mode information (rem_intra_luma_pred_mode or intra_luma_mpm_remainder). In this document, the MPM list may be called various terms such as MPM candidate list and candModeList.

When MIP is applied to the current block, a separate mpm flag (ex. intra_mip_mpm_flag), mpm index (ex. intra_mip_mpm_idx), and remaining intra prediction mode information (ex. intra_mip_mpm_remainder) for MIP may be signaled, and the not planar flag may not be signaled.

In other words, when an image is generally partitioned into blocks, the current block to be coded and neighboring blocks have similar image characteristics. Therefore, the current block and neighboring blocks are highly likely to have the same or similar intra prediction modes. Thus, the encoder can use the intra-prediction mode of the neighboring block to encode the intra-prediction mode of the current block.

A most probable modes (MPM) list for a current block of a coding apparatus may be configured. The MPM list may also be referred to as an MPM candidate list. Here, the MPM may mean a mode used to improve coding efficiency by considering the similarity between the current block and neighboring blocks during intra prediction mode coding. As described above, the MPM list may include the planar mode or may exclude the planar mode. For example, when the MPM list includes a planar mode, the number of candidates in the MPM list may be 6. And, when the MPM list does not include the planar mode, the number of candidates in the MPM list may be five.

The encoding apparatus may perform prediction based on various intra prediction modes, and may determine an optimal intra prediction mode based on rate-distortion optimization (RDO) based thereon. In this case, the encoding apparatus may determine the optimal intra prediction mode using only the MPM candidates and planar mode configured in the MPM list, or may further use the remaining intra-prediction modes as well as MPM candidates and planar modes configured in the MPM list. Specifically, if the intra prediction type of the current block is a specific type (eg, LIP, MRL, or ISP) rather than a normal intra prediction type, the encoding apparatus considers only the MPM candidates and planar mode as the intra prediction mode candidates for the current block, and then determines the optimal intra prediction mode. That is, in this case, the intra prediction mode for the current block may be determined only from among the MPM candidates and the planar mode, and in this case, the mpm flag may not be encoded/signaled. In this case, the decoding apparatus may estimate that the mpm flag is 1 without separately signaling the mpm flag.

Meanwhile, in general, when the intra prediction mode of the current block is not a planar mode and is one of MPM candidates in the MPM list, the encoding apparatus generates an mpm index (mpm idx) indicating one of the MPM candidates. If the intra prediction mode of the current block is not included in the MPM list, MPM remainder information (remaining intra prediction mode information) indicating the same mode as the intra prediction mode of the current block among the remaining intra prediction modes not included in the MPM list (and planar mode) is generating. The MPM reminder information may include, for example, an intra_luma_mpm_remainder syntax element.

The decoding apparatus obtains intra prediction mode information from the bitstream. As described above, the intra prediction mode information may include at least one of an MPM flag, a non-planar flag, an MPM index, or MPM reminder information (remaining intra prediction mode information). The decoding apparatus may construct an MPM list. The MPM list is configured identically to the MPM list configured in the encoding apparatus. That is, the MPM list may include intra prediction modes of neighboring blocks or may further include specific intra prediction modes according to a predetermined method.

The decoding apparatus may determine the intra prediction mode of the current block based on the MPM list and the intra prediction mode information. For example, when the value of the MPM flag is 1, the decoding apparatus derives a planar mode as an intra prediction mode of the current block (based on a not planar flag) or selects a candidate indicated by the MPM index from among MPM candidates in the MPM list. It can be derived as an intra prediction mode of the current block. Here, the MPM candidates may indicate only candidates included in the MPM list, or may include not only candidates included in the MPM list but also a planar mode that may be applied when the value of the MPM flag is 1.

As another example, when the value of the MPM flag is 0, the decoding apparatus may derive an intra prediction mode indicated by the remaining intra prediction mode information (which may be called mpm remainder information) among the remaining intra prediction modes not included in the MPM list and the planar mode as an intra prediction mode of the current block. Meanwhile, as another example, when the intra prediction type of the current block is a specific type (eg, LIP, MRL, or ISP), the decoding apparatus may derive the candidate indicated by the MPM flag in the planar mode or the MPM list as the intra prediction mode of the current block without parsing/decoding/confirming the MPM flag.

The coding device derives neighboring reference samples of the current block (S910). When intra prediction is applied to the current block, neighboring reference samples to be used for intra prediction of the current block may be derived. The neighboring reference samples of the current block include a total of 2×nH samples adjacent to the left boundary of the current block of size nW×nH and samples neighboring to the bottom-left of the current block of size nW×nH, and a total 2×nW samples adjacent to the top boundary of the current block and samples neighboring to the top-right of the current block of size nW×nH and 1 sample neighboring to the top-left of the current block. Alternatively, the neighboring reference samples of the current block may include samples top neighboring samples in a plurality of columns and left neighboring samples in a plurality of rows. In addition, the neighboring reference samples of the current block may include a total of nH samples adjacent to the right boundary of the current block of size nW×nH, a total of nW samples adjacent to the bottom boundary of the current block of size nW×nH, and 1 sample neighboring to the bottom-right of the current block of size nW×nH.

Meanwhile, when MRL is applied (ie, when the value of the MRL index is greater than 0), the neighboring reference samples may be located on lines 1 to 2 instead of line 0 adjacent to the current block on the left/upper side. In this case, the number of neighboring reference samples may be further increased. Meanwhile, when ISP is applied, the neighboring reference samples may be derived in units of sub-partitions.

The coding apparatus derives prediction samples by performing intra prediction on the current block (S920). The coding apparatus may derive the prediction samples based on the intra prediction mode/type and the neighboring samples. The coding apparatus may derive a reference sample according to an intra prediction mode of the current block among neighboring reference samples of the current block, and may derive a prediction sample of the current block based on the reference sample.

Meanwhile, when intra prediction is applied, an intra prediction mode applied to the current block may be determined using intra prediction modes of neighboring blocks. For example, the decoding apparatus may select one of mpm candidates in a most probable mode (mpm) list list derived based on an intra prediction mode of a neighboring block (eg, a left and/or an upper neighboring block) of a current block and additional candidate modes, based on received mpm index, or may select one of the remaining intra prediction modes not included in the mpm candidates (and planar mode) based on the remaining intra prediction mode information. The mpm list can be configured to include or not include planar modes as candidates. For example, if the mpm list includes the planar mode as a candidate, the mpm list may have 6 candidates, and if the mpm list does not include the planar mode as a candidate, the mpm list may have 5 candidates. If the mpm list does not include a planar mode as a candidate, a non-planar flag (ex. intra_luma_not_planar_flag) indicating whether the intra prediction mode of the current block is not a planar mode may be signaled. For example, the mpm flag may be signaled first, and the mpm index and non-planar flag may be signaled when the value of the mpm flag is 1. Also, the mpm index may be signaled when the value of the non-planar flag is 1. Here, the fact that the mpm list is configured not to include the planar mode as a candidate is not that the planar mode is not mpm, but rather that the planar mode is always considered as mpm, so a not planar flag is first signaled to determine whether the planar mode is the planar mode. to check first.

For example, whether the intra prediction mode applied to the current block is among mpm candidates (and planar mode) or remaining mode may be indicated based on an mpm flag (ex. intra_luma_mpm_flag). A value of mpm flag 1 may indicate that the intra prediction mode for the current block is within mpm candidates (and planar mode), and a value of mpm flag 0 may indicate that the intra prediction mode for the current block is not within mpm candidates (and planar mode). A value of not planar flag (ex. intra_luma_not_planar_flag) 0 may indicate that the intra prediction mode of the current block is the planar mode, and a value of not planar flag 1 may indicate that the intra prediction mode of the current block is not the planar mode. The mpm index may be signaled in the form of an mpm_idx or intra_luma_mpm_idx syntax element, and the remaining intra prediction mode information may be signaled in the form of a rem_intra_luma_pred_mode or intra_luma_mpm_remainder syntax element. For example, the remaining intra prediction mode information may indicate one of all intra prediction modes by indexing remaining intra prediction modes not included in mpm candidates (and planar mode) in order of prediction mode number. The intra prediction mode may be an intra prediction mode for a luma component (sample). Hereinafter, intra prediction mode information may include at least one of mpm flag (ex. intra_luma_mpm_flag), not planar flag (ex. intra_luma_not_planar_flag), mpm index (ex. mpm_idx or intra_luma_mpm_idx), or remaining intra prediction mode information (rem_intra_luma_pred_mode or intra_luma_mpm_remainder). In this document, the mpm list may be called various terms such as an mpm candidate list, a candidate mode list (candModeList), and a candidate intra prediction mode list.

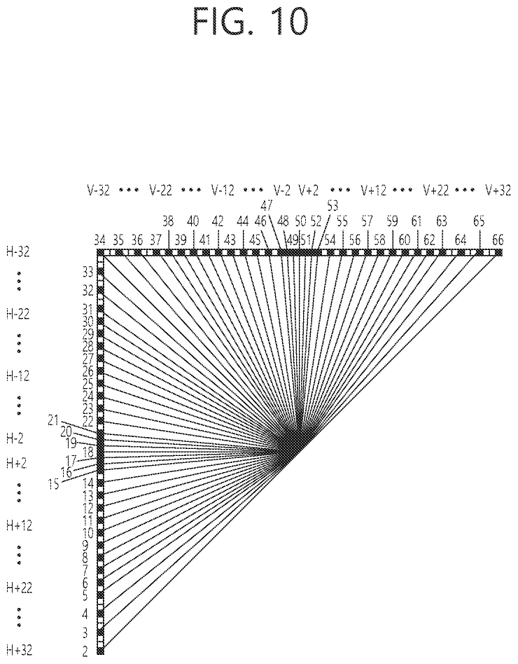

FIG. 10 illustrates an example of intra prediction modes to which embodiments of the present disclosure may be applied.

Referring to FIG. 10, an intra prediction mode with horizontal direction and an intra prediction mode with vertical direction can be distinguished around intra prediction mode no. 34 with an upward-left diagonal prediction direction. H and V of FIG. 10 refer to horizontal and vertical directions, respectively, and numbers −32 to 32 represent displacements of 1/32 units on a sample grid position. Intra prediction modes 2 to 33 have horizontal directionality, and intra prediction modes 34 to 66 have vertical directionality. The 18th and 50th intra prediction modes represent horizontal intra prediction modes and vertical intra prediction modes, respectively, while the 2nd intra prediction mode is called the downward-left diagonal intra prediction mode, and the 34th intra prediction mode may be referred to as an upper-left diagonal intra prediction mode, and the 66th intra prediction mode may be referred to as an upper-left diagonal intra prediction mode.

Meanwhile, DIMD (Decoder Side Intra Mode Derivation, DIMD) mode, a method of intra prediction, may be used to perform prediction for the current block. The DIMD mode, a method of intra prediction, will be discussed below.

For example, DIMD mode may be called Decoder Side Intra Mode Derivation Mode, Decoder Intra Mode Derivation Mode, Decoder Side Intra Prediction Mode, Decoder Intra Prediction Mode, etc.

In addition, for example, DIMD mode may be called DIMD intra mode. In addition, DIMD mode may be called DIMD intra prediction mode or DIMD prediction mode.

For example, DIMD mode may be used by deriving the intra prediction mode in the encoder and decoder, rather than directly transmitting intra prediction mode information. For example, the horizontal gradient and vertical gradient may be derived from the second neighboring reference column and row, and a HoG (Histogram of gradients) may be constructed from them.

In the present disclosure, intra mode may be referred to as intra prediction mode. In addition, intra mode and intra prediction mode can be used interchangeably.

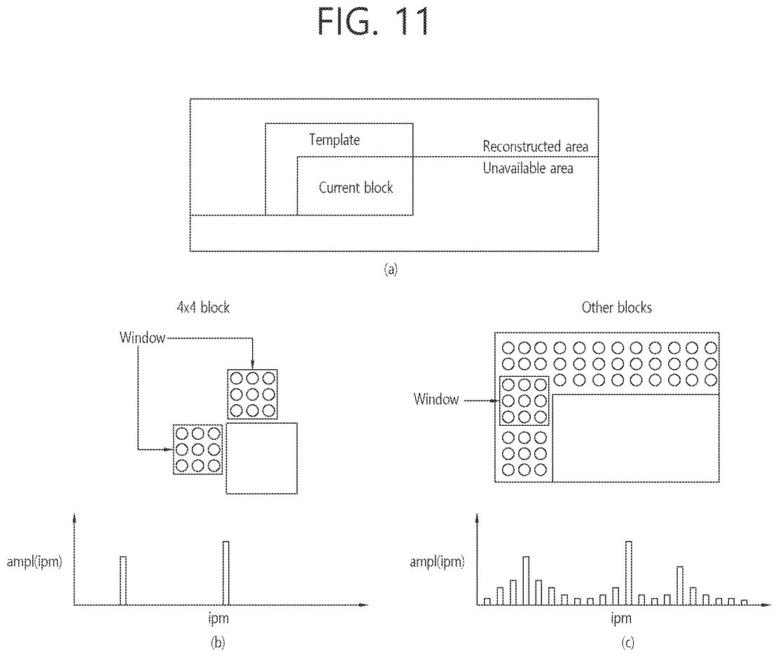

FIG. 11 exemplarily shows a method of configuring a Histogram of Gradiant (HoG) used to derive an intra prediction mode for the DIMD mode.

For example, (a) of FIG. 11 exemplarily shows a template used to derive an intra prediction mode for DIMD mode. And, (b) of FIG. 11 and (c) of FIG. 11 show the HoG configuration method used to derive the intra prediction mode for the DIMD mode.

For example, according to (b) of FIG. 11, Hog may be derived by applying a Sobel filter using the L-shaped columns and rows of 3 pixels neighboring the current block. For example, if the boundaries of blocks exist in different CTUs, the neighboring pixels of the current block may not be used for texture analysis.

Meanwhile, the Sobel filter may also be called a Sobel operator and is an efficient filter for detecting edges. When using the Sobel filter, two types of Sobel filters may be used: a Sobel filter for vertical direction and a Sobel filter for horizontal direction.

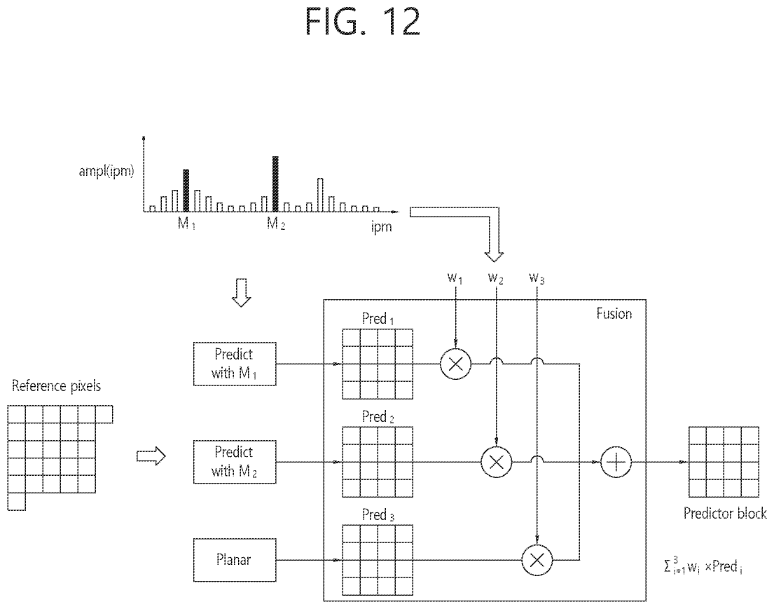

FIG. 12 exemplarily shows a method of configuring a prediction block by applying DIMD mode.

For example, according to FIG. 12, two intra modes with the largest histogram amplitude may be selected, and the final prediction block may be formed by blending the prediction block predicted using the two modes and the planar mode. In other words, the intra mode with the largest histogram amplitude and the intra mode with the second largest histogram amplitude may be selected, and the final prediction block may be formed by blending the prediction block predicted using the two modes and the planar mode. At this time, the weights for the modes may be derived from the amplitude of the histogram. In addition, for example, DIMD flag information may be transmitted in block units to check whether DIMD is being used. At this time, the DIMD flag information may indicate whether DIMD mode is applied.

For example, the weight for the intra mode with the largest histogram amplitude may be calculated using the following equation.

$${w}_{1} = \frac{43}{64} \times \frac{ampl ( {M}_{1} )}{ampl ( {M}_{1} ) + ampl ( {M}_{2} )} \qquad [ Equation 1 ]$$

In addition, the weight for the intra mode with the second largest histogram amplitude may be calculated using the following equation.

$${w}_{2} = \frac{43}{64} \times \frac{ampl ( {M}_{2} )}{ampl ( {M}_{1} ) + ampl ( {M}_{2} )} \qquad [ Equation 2 ]$$

In addition, the weight for the planar mode can be calculated using the following equation.

$${w}_{3} = \frac{21}{64} \qquad [ Equation 3 ]$$

Meanwhile, TIMD (Template-based Intra Mode Derivation) mode, a method of intra prediction, may be used to predict the current block. The TIMD mode, a method of intra prediction, will be discussed below.

For example, TIMD mode may be called template-based Intra Mode Derivation mode, Template Intra Mode Derivation mode, etc.

Also, for example, TIMD mode may be called TIMD intra mode. In addition, TIMD mode may be called TIMD intra prediction mode or TIMD prediction mode.

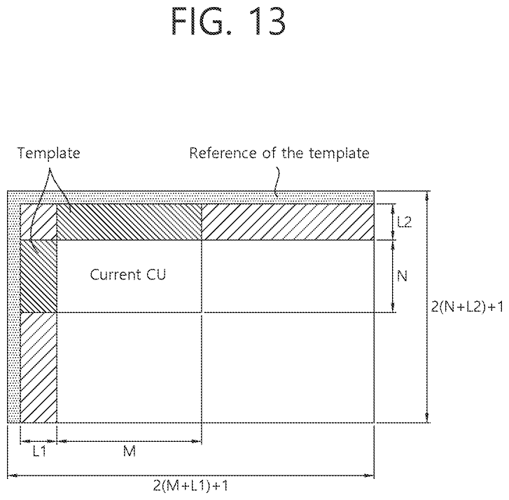

FIG. 13 exemplarily shows a template used to derive an intra prediction mode for the TIMD mode.

When TIMD mode is used, the decoder may derive an intra mode of a current CU using previously decoded neighboring pixels. For example, prediction samples for neighboring template are derived based on neighboring reference samples of the neighboring template of the current block (or current CU), and the intra mode of the current block (or current CU) may be derived by comparing the derived prediction samples of the neighboring template with reconstructed samples of the neighboring template. Specifically, after deriving the SATD (Sum of Absolute Transformed Difference) of the prediction samples derived based on the neighboring reference samples of the neighboring template and the reconstructed samples of the neighboring template, the mode with the minimum SATD may be selected as the intra mode of the current block.

For example, referring to FIG. 13, prediction samples of the template may be derived based on neighboring reference samples located outside the template, that is, Reference of the template. After deriving the SATD between the derived predicted samples of the template and the reconstructed samples of the template already derived during the reconstruction process, the mode with the minimum SATD may be selected as the intra mode of the current block. Since the template is an area where reconstruction has already been completed in the decoding order, this method may be used.

In addition, for example, for each MPM candidate in the MPM list, the SATD between the predicted samples and the reconstructed samples derived from the template area may be calculated, and then the mode with the smallest SATD may be selected as the intra mode of the current block.

Alternatively, after selecting two prediction modes with the smallest SATD, the prediction blocks for the two prediction modes may be blended using a weighted sum method and used as prediction block for the current block. In other words, the prediction blocks for the prediction mode with the smallest SATD and the prediction mode with the next smallest SATD may be blended using a weighted sum method and used as the prediction block for the current block.

Meanwhile, the two modes with the smallest SATD cost may be used to blend with the weight to be used as the weighted intra prediction for the current CU. The method of blending the two selected modes may be applied when the equation below is satisfied.

$$costMode 2 < 2 * costMode 1 \qquad [ Equation 4 ]$$

For example, if the Equation is true, the two modes are blended to generate a prediction block, otherwise, only one mode with the minimum SATD may be selected.

In addition, when blending two prediction blocks, the weight may be calculated using the equation below.

$$weight 1 = costMode 2 / ( costMode 1 + costMode 2 ) \qquad [ Equation 5 ]$$

$$weight 2 = 1 - weight 1$$

Here, costMode 1 may be the SATD cost of mode 1, and costMode 2 may be the SATD cost of mode 2.

Meanwhile, in general, when an image is divided into blocks, the current block to be coded and neighboring blocks have similar image characteristics. Therefore, there is a high probability that the current block and neighboring blocks have the same or similar intra prediction modes. Accordingly, the encoder may use the intra prediction mode of the neighboring block to encode the intra prediction mode of the current block. For example, the encoder/decoder may construct a most probable modes (MPM) list for the current block. The MPM list may also be referred to as an MPM candidate list. Here, MPM may refer to a mode used to improve coding efficiency by considering the similarity between the current block and neighboring blocks when coding in intra prediction mode.

In performing intra prediction, a method of deriving an intra prediction mode using not only the existing MPM candidate list described above but also the secondary MPM candidate list will be described below.

In the present disclosure, the existing MPM list may be referred to as a primary MPM (primary most probable mode, PMPM) list, a first MPM list, or the like. The secondary MPM (secondary most probable mode, SMPM) list may be referred to as the second MPM list.

The existing MPM list may consist of 6 candidates, and the secondary MPM list may consist of 16 candidates. For example, a general MPM list may first be constructed with 22 candidates, the first 6 candidates in the general MPM list may be included in the primary MPM list, and the remaining candidates may be included in the secondary MPM list. The first candidate in the general MPM list may be planar mode. The remaining candidates may be constructed with default modes and directional modes with an offset from first two available directional modes among an intra mode of the left (L) neighboring block, an intra mode of above (A) neighboring block, an intra mode of below-left (BL) neighboring block, an intra mode of above-right (AR) neighboring block, an intra mode of above-left (AL) neighboring block, and directional modes of neighboring blocks.

For example, when a CU block is oriented in the vertical direction, the order of neighboring blocks may be the above (A) neighboring block, the left (L) neighboring block, the below-left (BL) neighboring block, the above-right (AR) neighboring block, and the above-left (AL) neighboring block. Otherwise, the order of the neighboring blocks may be the left (L) neighboring block, the above (A) neighboring block, the below-left (BL) neighboring block, the above-right (AR) neighboring block, and the above-left (AL) neighboring block.

The primary MPM flag may be parsed before the secondary MPM flag. At this time, the primary MPM flag may represent whether the primary MPM mode is used, and the secondary MPM flag may represent whether the secondary MPM mode is used. For example, if the value of the primary MPM flag is 1, the primary MPM index information may be parsed. At this time, the primary MPM index information may indicate which candidate has been selected from the primary MPM list.

For example, if the value of the primary MPM flag is 0, the secondary MPM flag may be parsed. For example, if the value of the secondary MPM flag information is 1, the secondary MPM index information may be parsed. At this time, the secondary MPM index information may indicate which candidate has been selected from the secondary MPM list. Or, for example, if the value of the secondary MPM flag is 0, the remaining mode information may be parsed.

In the present disclosure, it proposes a method of deriving a new prediction mode using an intra prediction mode derived based on information of a template on the decoder side, such as DIMD and TIMD mode, and using the prediction modes derived as above as candidates for the MPM list and secondary MPM list when constructing an MPM list and a secondary MPM list.

The existing MPM list and secondary MPM list as described above may be implemented in ECM (Enhanced Compression Model). According to ECM, after a total of 22 modes may be derived as MPM candidates, modes 0 to 5 may be used as candidates for the primary MPM list, and modes 6 to 21 may be used as candidates for the secondary MPM list. At this time, mode 0 is fixed as planar mode. That is, as described above, ECM derives a total of 22 intra modes and then uses the higher-order modes as primary MPM candidates and the lower-order modes as secondary MPM candidates, so the candidate derivation methods of the primary MPM list and the secondary MPM list may share the same structure. For convenience of explanation, in this disclosure, the method of generating the primary MPM list and the method of generating the secondary MPM list show separately.

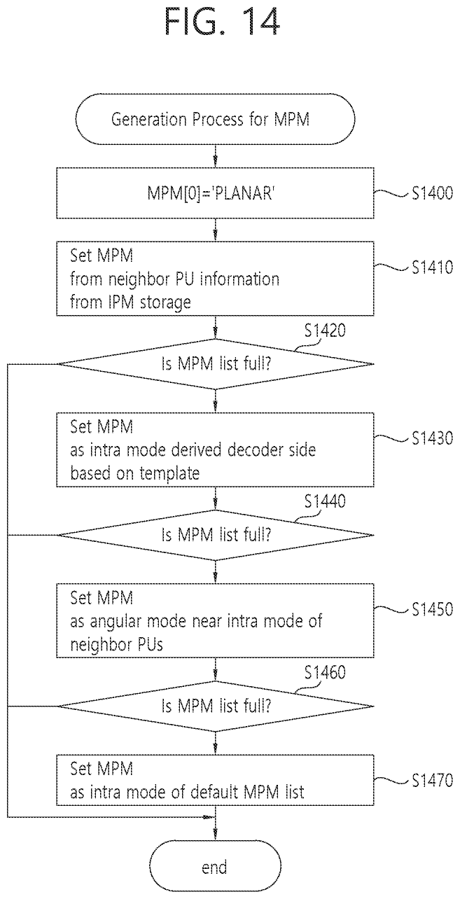

FIG. 14 shows an example of a method for constructing an MPM list in intra prediction. Here, the MPM list may refer to the primary MPM list, or may refer to the entire MPM list including the primary and secondary MPM lists. At this time, the entire MPM list may be referred to as a general MPM list.

Referring to FIG. 14, the MPM list may be structured as follows.

The planar mode may be derived as the first candidate in the MPM list (S1400). That is, the first candidate mode inserted into the MPM list may be set to planar mode.

Next, candidate mode(s) may be derived based on the neighboring PU information and added to the MPM list (S1410). For example, the neighboring PU information may include the intra prediction mode of the neighboring PU or the intra prediction mode stored in the IPM buffer of the neighboring PU.

Here, the neighboring PUs may include at least one of the left (L) neighboring block, the above (A) neighboring block, the below-left (BL) neighboring block, the above-right (AR) neighboring block, and the above-left (AL) neighboring block. For example, when at least one of the neighboring blocks is coded in an intra prediction mode, the intra prediction mode of the corresponding neighboring block may be derived as a candidate mode of the MPM list. Alternatively, for example, in the case of a neighboring block coded in an inter prediction mode among the neighboring blocks, the intra prediction mode stored in the IPM buffer of the corresponding neighboring block may be derived as a candidate mode of the MPM list. For example, when a neighboring block is coded in inter prediction mode, the prediction mode may be stored in the IPM buffer for a block at a position specified based on the motion vector of the neighboring block coded in the inter prediction mode. In this case, the intra prediction mode stored in the IPM buffer may be used.

It may be determined whether the MPM list is filled with the predetermined number of candidates (S1420), and if the number of candidates in the MPM list is not filled, the intra mode derived from the template-based decoder side may be derived and added to the MPM list (S1430).

In step S1430, if the MPM list is not filled with the predetermined number of candidates (S1440), the neighboring angular mode of the intra mode of the neighboring PU(s) may be derived and added to the MPM list (S1450).

In step S1450, if the MPM list is not filled with the predetermined number of candidates (S1460), the default mode(s) may be added to the MPM list (S1470).

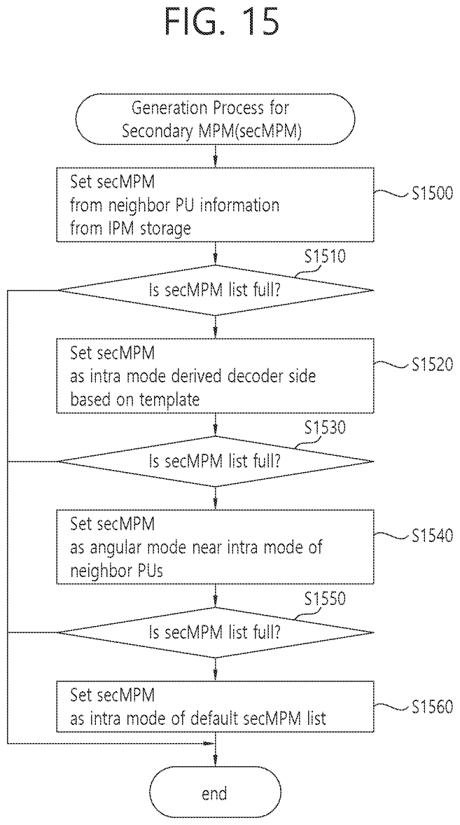

FIG. 15 shows an example of a method for constructing a secondary MPM list in intra prediction.

Referring to FIG. 15, the secondary MPM list may be constructed as follows.

Candidate mode(s) may be derived based on neighboring PU information and added to the secondary MPM list (S1500), For example, the neighboring PU information may include the intra prediction mode of the neighboring PU or the intra prediction mode stored in the IPM buffer of the neighboring PU.

It may be determined whether the secondary MPM list is filled with the predetermined number of candidates (S1510), and if the number of candidates in the secondary MPM list is not filled, the intra mode derived from the template-based decoder side may be derived and added to the secondary MPM list (S1520).

In step S1520, if the secondary MPM list is not filled with the predetermined number of candidates (S1530), the neighboring angular mode of the intra mode of the neighboring PU(s) may be derived and added to the secondary MPM list (S1540).

In step S1540, if the secondary MPM list is not filled with the predetermined number of candidates (S1550), the default mode(s) may be added to the secondary MPM list (S1560).

As described above, when constructing the MPM list and the secondary MPM list, the intra prediction mode derived based on the template on the decoder side (e.g., the intra prediction mode derived based on the TIMD or DIMD mode) may be used as a candidate mode. At this time, a template-based intra prediction mode on the decoder side (e.g., an intra prediction mode derived based on a TIMD or DIMD mode) may be derived, and then, instead of constructing an additional candidate mode using the already derived TIMD or DIMD mode, an angular mode may be additionally derived using only the prediction mode of a neighboring PU or an intra prediction mode stored in the IPM buffer of a neighboring PU.

Accordingly, the present disclosure proposes a method of constructing additional candidate mode(s) using an intra prediction mode derived based on a template at the decoder side (e.g., an intra prediction mode derived based on a TIMD or DIMD mode).

In an embodiment, a new intra prediction mode may be derived based on a template-based intra prediction mode on the decoder side (e.g., an intra prediction mode derived based on TIMD or DIMD mode). For example, a template-based intra prediction mode on the decoder side (e.g., an intra prediction mode derived based on TIMD or DIMD mode) may be derived, and a neighboring angular mode of the template-based intra prediction mode on the decoder side (e.g., an intra prediction mode derived based on TIMD or DIMD mode) may be additionally derived and may be used as a candidate mode for the MPM list and the secondary MPM list.

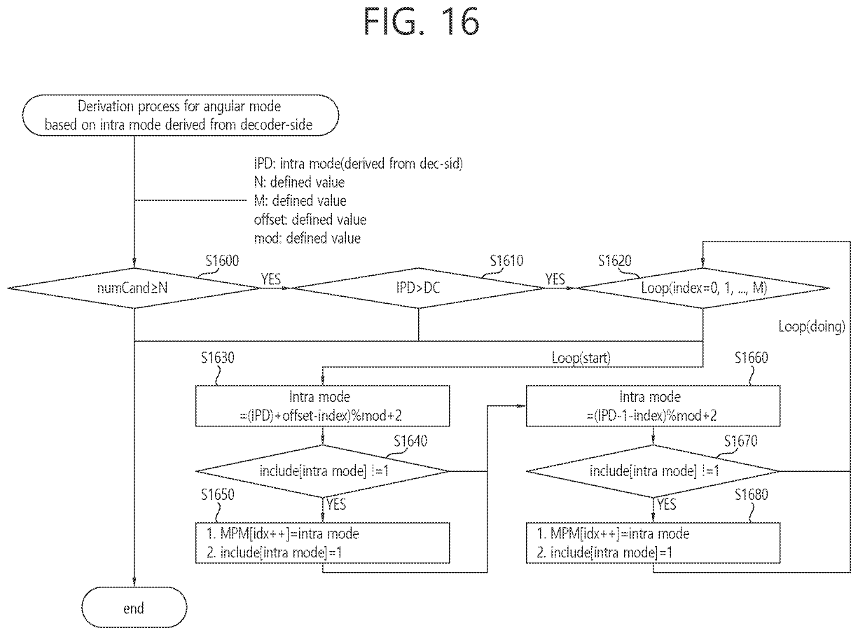

FIG. 16 shows an example of a method for deriving a neighboring angular mode based on an intra prediction mode derived at the decoder side according to an embodiment of the present disclosure.

Referring to FIG. 16, when the number of prediction modes (e.g., numCand) given so far is more than a certain value (e.g., N), additional prediction mode(s) may be derived by referring to the intra prediction mode (e.g. IPD) derived at the decoder side. At this time, it is performed only when the IPD is not in planar mode or DC mode, and iteration to derive additional modes may be performed for a given value (e.g., M). The neighboring angular mode may be calculated using predefined offset and mode values based on the IPD.

Here, the intra prediction mode (e.g., IPD) derived at the decoder side may mean an intra prediction mode derived based on the template-based intra prediction mode (e.g., an intra prediction mode derived based on TIMD or DIMD mode) derived at the decoder side described above.

As a specific example, it may be determined whether the number of prediction modes given so far (e.g., numCand) is greater than or equal to a certain value (e.g., N) (S1600), and may be determined whether the intra prediction mode (e.g., IPD) derived at the decoder side has a mode number greater than the DC mode (S1610).

That is, when the number of intra modes (i.e., candidate modes) derived so far (e.g., numCand) is greater than or equal to a certain number (e.g., N) and the mode number of the intra prediction mode (e.g., IPD) derived on the decoder side is greater than DC, until a given value (e.g. M) is reached (S1620), the following process may be repeated (S1630 to S1680). Steps S1630 to S1680 represent an example of deriving a neighboring angular mode based on an intra prediction mode (e.g., IPD) derived at the decoder side.

For example, the neighboring angular mode may be calculated as:

$$intra mode = ( IPD + offset - index ) \% mod + 2 , \\ and intra mode = ( IPD - 1 - index ) \% mod + 2$$

Here, the IPD may be the mode number of the intra prediction mode derived from the decoder side, and the offset, index, and mode may be predetermined values, for example, the offset may be 61, the index may be 0, 1, 2, and 3, and the mod may be 64.

The neighboring angular mode derived as above may be added as a candidate mode to the MPM list and secondary MPM list.

In addition, in the present disclosure, when constructing the MPM list and the secondary MPM list, a angular mode may be derived based on the intra prediction mode (e.g., IPD) derived at the decoder side as described above, and the derived angular mode may be used as an intra prediction candidate.

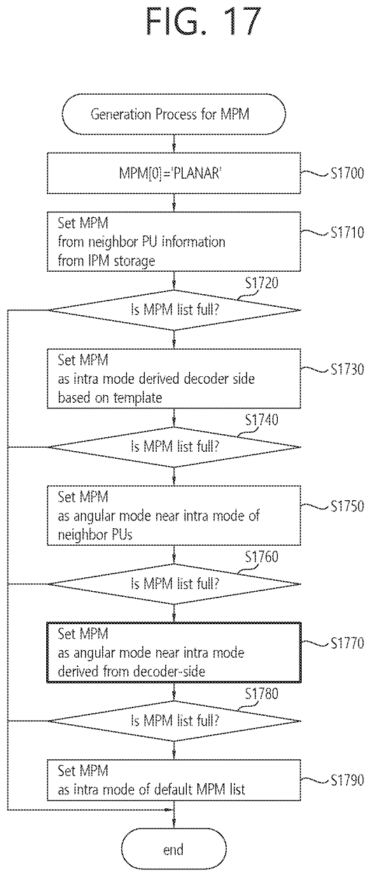

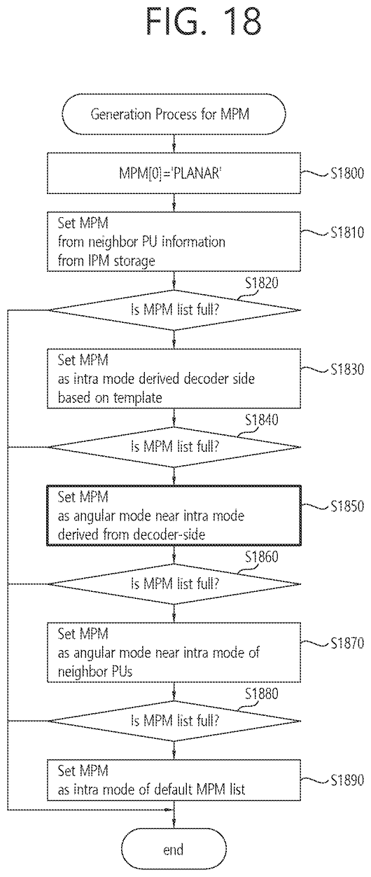

FIGS. 17 and 18 show an example of a method for constructing an MPM list according to an embodiment of the present disclosure.

Here, the MPM list may refer to the primary MPM list, or may refer to the entire MPM list including the primary and secondary MPM lists. At this time, the entire MPM list may be referred to as a general MPM list.

Referring to FIGS. 17 and 18, an intra prediction mode (IPD) derived at the decoder side may be derived, and a neighboring angular mode may be derived based on the derived IPD and may be used as a candidate mode in the MPM list. At this time, since the order of candidates in the MPM list also changes depending on the insertion order of the candidates, the order of MPM candidates may be changed as shown in FIG. 17 or 18 depending on the embodiment. For example, the neighboring angular mode derived based on the IPD may be inserted after the angular mode derived from neighboring PU information as shown in FIG. 17, or may be inserted before the angular mode derived from neighboring PU information as shown in FIG. 18.

Here, the intra prediction mode (IPD) derived on the decoder side may refer to the above-described template-based intra prediction mode derived on the decoder side, for example, an intra prediction mode derived based on TIMD or DIMD mode.

As a specific example, the planar mode may be derived as the first candidate in the MPM list (S1700, S1800), That is, the first candidate mode inserted into the MPM list may be set to planar mode.

Next, candidate mode(s) may be derived based on the neighboring PU information and added to the MPM list (S1710, S1810). For example, the neighboring PU information may include the intra prediction mode of the neighboring PU or the intra prediction mode stored in the IPM buffer of the neighboring PU.

It may be determined whether the MPM list is filled with the predetermined number of candidates (S1720, S1820), and if the number of candidates in the MPM list is not filled, an intra mode derived from the template-based decoder side may be derived and added to the MPM list. (S1730, S1830). Here, the intra mode derived from the template-based decoder side may mean the above-described TIMD or DIMD mode.

If the MPM list is not filled with the predetermined number of candidates in the previous process (S1740, S1840), an additional intra prediction mode may be derived and used as a candidate mode.

For example, as shown in FIG. 17, the neighboring angular mode of the intra mode of the neighboring PU(s) may first be derived and added to the MPM list (S1750). Next, if the MPM list is not filled with the predetermined number of candidates (S1760), the neighboring angular mode of the intra mode derived on the template-based decoder side (e.g., intra prediction mode derived based on TIMD or DIMD mode) may be derived and added to the MPM list (S1770).

Or, for example, as shown in FIG. 18, the neighboring angular mode of the intra mode (e.g., intra prediction mode derived based on the TIMD or DIMD mode) derived from the template-based decoder side may first be derived and added to the MPM list (S1850). Next, if the MPM list is not filled with the predetermined number of candidates (S1860), the neighboring angular mode of the intra mode of the neighboring PU(s) may be derived and added to the MPM list (S1870).

Here, the neighboring angular mode derived based on the intra mode (e.g., intra prediction mode derived based on TIMD or DIMD mode) derived from the template-based decoder side may be derived as shown in FIG. 15 described above, and as an example, amy be calculated as follows.

$$intra mode = ( IPD + offset - index ) \% mod + 2 , \\ and intra mode = ( IPD - 1 - index ) \% mod + 2$$

After the above process, if the MPM list is not filled with the predetermined number of candidates (S1780, S1880), the default mode(s) may be derived and added to the MPM list (S1790, S1890). Here, the default mode(s) may be predetermined intra prediction mode(s).

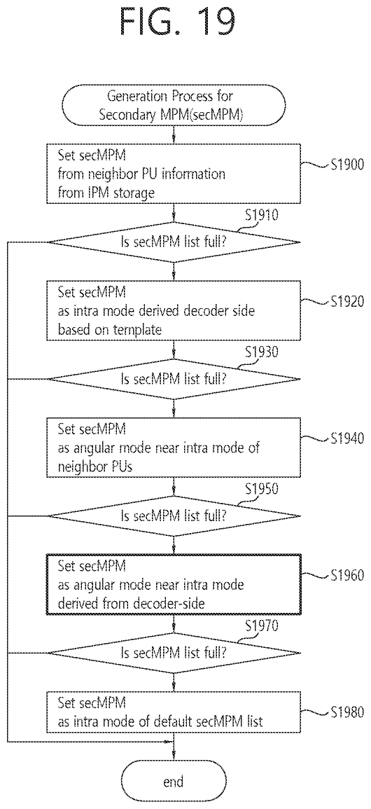

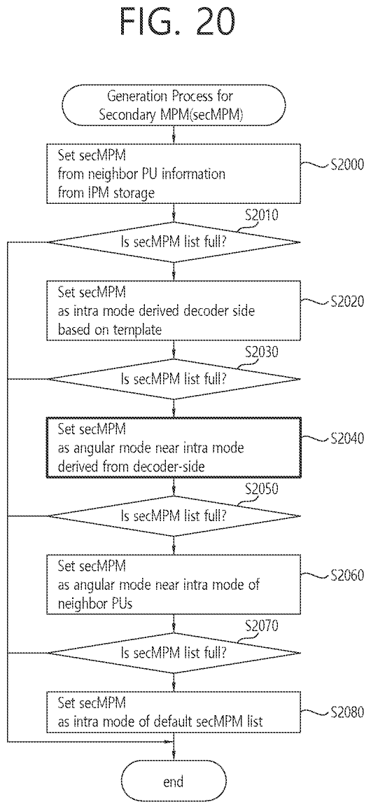

FIGS. 19 and 20 show an example of a method for constructing a secondary MPM list according to an embodiment of the present disclosure.

Referring to FIGS. 19 and 20, an intra prediction mode (IPD) derived at the decoder side may be derived, and a neighboring angular mode may be derived based on the derived IPD and used as a candidate mode for the secondary MPM list. At this time, since the order of candidates in the secondary MPM list also changes depending on the insertion order of the candidates, the order of secondary MPM candidates may be changed as shown in FIG. 19 or FIG. 20 according to the embodiment. For example, the neighboring angular mode derived based on the IPD may be inserted after the angular mode derived from neighboring PU information as shown in FIG. 19, or may be inserted before the angular mode derived from neighboring PU information, as shown in FIG. 20.

Here, the intra prediction mode (IPD) derived on the decoder side may refer to the template-based intra prediction mode derived from the decoder side described above, for example, an intra prediction mode derived based on TIMD or DIMD mode.

As a specific example, candidate mode(s) may be derived based on neighboring PU information and added to the secondary MPM list (S1900, S2000). For example, the neighboring PU information may include the intra prediction mode of the neighboring PU or the intra prediction mode stored in the IPM buffer of the neighboring PU.

It may be determined whether the secondary MPM list is filled with the predetermined number of candidates (S1910, S2010), and if the number of candidates in the secondary MPM list is not filled, the intra mode derived from the template-based decoder side may be derived and added to the secondary MPM list (S1920, S2020). Here, the intra mode derived from the template-based decoder side may mean an intra prediction mode derived based on the TIMD or DIMD mode described above.

If the secondary MPM list is not filled with the predetermined number of candidates in the previous process (S1930, S2030), an additional intra prediction mode may be derived and used as a candidate mode for the secondary MPM list.

For example, as shown in FIG. 19, the neighboring angular mode of the intra mode of the neighboring PU(s) may be first derived and added to the secondary MPM list (S1940). Next, if the secondary MPM list is not filled with the predetermined number of candidates (S1950), the neighboring angular mode of the intra mode (e.g., intra prediction mode derived based on TIMD or DIMD mode) derived from the template-based decoder side may be derived and added to the secondary MPM list (S1960).

Or, for example, as shown in FIG. 20, the neighboring angular mode of the intra mode (e.g., intra prediction mode derived based on the TIMD or DIMD mode) derived on the template-based decoder side may be first derived and added to the secondary MPM list (S2040). Next, if the secondary MPM list is not filled with the predetermined number of candidates (S2050), the neighboring angular mode of the intra mode of the neighboring PU(s) may be derived and added to the secondary MPM list (S2060).

Here, the neighboring angular mode derived based on the intra mode (i.e., intra prediction mode derived based on TIMD or DIMD mode) derived at the template-based decoder side may be derived as shown in FIG. 15 described above, and as an example, may be calculated as follows.

$$intra mode = ( IPD + offset - index ) \% mod + 2 , \\ and intra mode = ( IPD - 1 - index ) \% mod + 2$$

If the secondary MPM list is not filled with the predetermined number of candidates after the above process (S1970, S2070), the default mode(s) may be derived and added to the secondary MPM list (S1980, S2080). Here, the default mode(s) may be predetermined intra prediction mode(s).

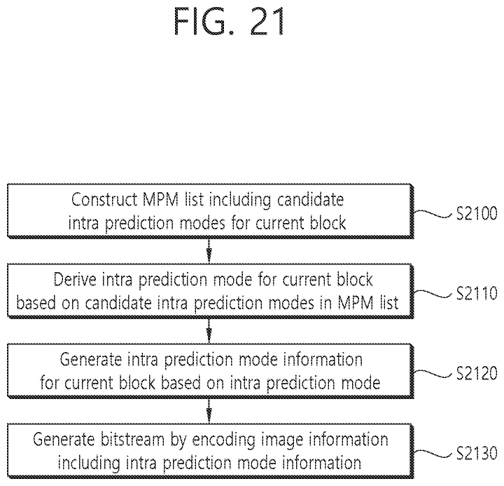

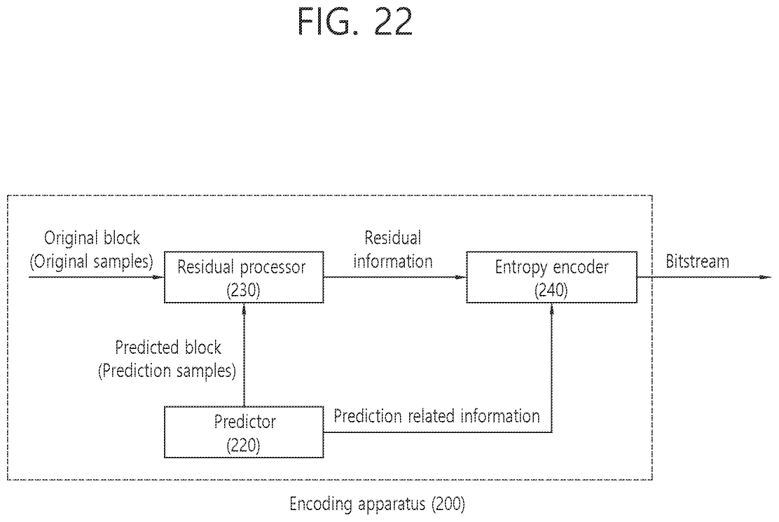

FIGS. 21 and 22 schematically show an example of a video/image encoding method and related components according to the embodiment(s) of the present disclosure.

The method disclosed in FIG. 21 may be performed by the encoding apparatus 200 disclosed in FIG. 2 or FIG. 22. Specifically, steps S2100 to S2120 of FIG. 21 may be performed by the predictor 220 of the encoding apparatus, and step S2130 of FIG. 21 may be performed by the entropy encoder 240 of the encoding apparatus. In addition, although not shown in FIG. 21, prediction samples for the current block may be generated by the predictor 220 of the encoding apparatus, and residual samples may be generated based on prediction samples for the current block by the residual processor 230 of the encoding apparatus, and residual information may be generated based on the residual samples, and a bitstream may be generated from residual information or prediction-related information by the entropy encoder 240 of the encoding apparatus. In addition, the method disclosed in FIG. 21 may be performed including the embodiments described above in the present disclosure. Therefore, in FIG. 21, detailed descriptions of content that overlaps with the above-described embodiments will be omitted or simplified.

Referring to FIG. 21, the encoding apparatus may construct a Most Probable Mode (MPM) list including candidate intra prediction modes for a current block (S2100). That is, the encoding apparatus may construct the MPM list for the current block according to the above-described embodiment(s).

For example, the MPM list may include at least one of a primary MPM list or a secondary MPM list. The primary MPM list may include 6 candidate intra prediction modes, and the secondary MPM list may include 16 candidate intra prediction modes.

In one embodiment, when constructing the MPM list, the encoding apparatus may construct a specific intra prediction mode as one of the candidate intra prediction modes of the MPM list. For example, the specific intra prediction mode may include at least one of an intra prediction mode derived based on a Template-based Intra Mode Derivation (TIMD) mode or an intra prediction mode derived based on a Decoder Side Intra Mode Derivation (DIMD) mode.

Here, the intra prediction mode derived based on the TIMD mode may be derived based on the template of the current block as described above, and may be an intra prediction mode derived based on the SATD (Sum of Absolute Transformed Difference) between the prediction sample of the template and the reconstructed sample of the template. The intra prediction mode derived based on the DIMD mode may be an intra prediction mode derived based on a histogram of gradients (HoG) from the neighboring reconstructed samples of the current block, as described above.

For example, the encoding apparatus may derive the neighboring angular mode of the intra prediction mode derived based on the TIMD mode based on the number of candidate intra prediction modes in the MPM list and construct it as one of the candidate intra prediction modes in the MPM list. Here, the neighboring angular mode of the intra prediction mode derived based on the TIMD mode may be derived as in the embodiment of FIG. 16 described above. In other words, if the MPM list is not filled with the predetermined number of candidates, the neighboring angular mode of the intra prediction mode derived based on the TIMD mode may be derived and constructed as one of the candidate intra prediction modes in the MPM list. At this time, in the case of a primary MPM list, the predetermined number of candidates may be 6, or in the case of a secondary MPM list, the predetermined number of candidates may be 16.

In addition, the encoding apparatus may add the intra prediction mode derived based on the TIMD mode and the neighboring angular mode of the intra prediction mode derived based on the TIMD mode into the MPM list in a preset order.

For example, the encoding apparatus may first derive candidate intra prediction modes including at least one of a first candidate intra prediction mode derived from a left neighboring block of the current block and a second candidate intra prediction mode derived from an upper neighboring block of the current block, and may add them to the MPM list. And, based on the number of candidate intra prediction modes in the MPM list, the encoding apparatus may add the intra prediction mode derived based on the TIMD mode after the first candidate intra prediction mode and the second candidate intra prediction mode to the MPM list.

In addition, for example, the encoding apparatus may derive candidate intra prediction modes including at least one of a first angular mode derived based on the first candidate intra prediction mode or a second angular mode derived based on the second candidate intra prediction mode, and add them to the MPM list. Here, the first angular mode and the second angular mode may be derived as in the embodiment of FIG. 16 described above. And then, based on the number of candidate intra prediction modes in the MPM list, the encoding apparatus may add the neighboring angular mode of the intra prediction mode derived based on the TIMD mode to the MPM list after the first angular mode and the second angular mode.

In addition, as another example, based on the number of candidate intra prediction modes in the MPM list, the encoding apparatus may add the neighboring angular mode of the intra prediction mode derived based on the TIMD mode to the MPM list before the first angular mode and the second angular mode.

The MPM list may include at least one of a primary MPM list or a secondary MPM list. In this case, the intra prediction mode derived based on the TIMD mode and the neighboring angular mode of the intra prediction mode derived based on the TIMD mode may be included in one of the primary MPM list or the secondary MPM list.

For example, when constructing candidates in the primary MPM list, if the primary MPM list is not filled with 6 candidate intra prediction modes, the intra prediction mode derived based on the TIMD mode and the neighboring angular mode of the intra prediction mode derived based on the TIMD mode may be added to the primary MPM list.

Alternatively, for example, when constructing candidates in the secondary MPM list, if the secondary MPM list is not filled with 16 candidate intra prediction modes, the intra prediction mode derived based on the TIMD mode and the neighboring angular mode of the intra prediction mode derived based on the TIMD mode may be added to the secondary MPM list.

Meanwhile, as an example, the encoding apparatus may derive the neighboring angular mode of the intra prediction mode derived based on the DIMD mode based on the number of candidate intra prediction modes in the MPM list and construct it as one of the candidate intra prediction modes in the MPM list. Here, the neighboring angular mode of the intra prediction mode derived based on the DIMD mode may be derived as in the embodiment of FIG. 16 described above. In other words, if the MPM list is not filled with the predetermined number of candidates, the neighboring angular mode of the intra prediction mode derived based on the DIMD mode may be derived and constructed as one of the candidate intra prediction modes in the MPM list. At this time, in the case of the primary MPM list, the predetermined number of candidates may be 6, or in the case of the secondary MPM list, the predetermined number of candidates may be 16.

In addition, the encoding apparatus may add the intra prediction mode derived based on the DIMD mode and the neighboring angular mode of the intra prediction mode derived based on the DIMD mode into the MPM list according to a preset order.

For example, the encoding apparatus may first derive candidate intra prediction modes including at least one of a first candidate intra prediction mode derived from a left neighboring block of the current block and a second candidate intra prediction mode derived from an upper neighboring block of the current block, and add them to the MPM list. And, based on the number of candidate intra prediction modes in the MPM list, the encoding apparatus may add the intra prediction mode derived based on the DIMD mode after the first candidate intra prediction mode and the second candidate intra prediction mode to the MPM list.

In addition, for example, the encoding apparatus may derive candidate intra prediction modes including at least one of a first angular mode derived based on the first candidate intra prediction mode or a second angular mode derived based on the second candidate intra prediction mode, and add them to the MPM list. Here, the first angular mode and the second angular mode may be derived as in the embodiment of FIG. 16 described above. And then, based on the number of candidate intra prediction modes in the MPM list, the encoding apparatus may add the neighboring angular mode of the intra prediction mode derived based on the DIMD mode to the MPM list after the first angular mode and the second angular mode.

In addition, as another example, based on the number of candidate intra prediction modes in the MPM list, the encoding apparatus may add the neighboring angular mode of the intra prediction mode derived based on the DIMD mode to the MPM list before the first angular mode and the second angular mode.

The MPM list may include at least one of a primary MPM list or a secondary MPM list. In this case, the intra prediction mode derived based on the DIMD mode and the neighboring angular mode of the intra prediction mode derived based on the DIMD mode may be included in one of the primary MPM list or the secondary MPM list.

For example, when constructing candidates in the primary MPM list, if the primary MPM list is not filled with 6 candidate intra prediction modes, the intra prediction mode derived based on the DIMD mode and the neighboring angular mode of the intra prediction mode derived based on the DIMD mode may be added to the primary MPM list.

Alternatively, for example, when constructing candidates in the secondary MPM list, if the secondary MPM list is not filled with 16 candidate intra prediction modes, the intra prediction mode derived based on the DIMD mode and the neighboring angular mode of the intra prediction mode derived based on the DIMD mode may be added to the secondary MPM list.

The encoding apparatus may derive an intra prediction mode for the current block based on the candidate intra prediction modes in the MPM list (S2110), and generate intra prediction mode information for the current block based on the intra prediction mode (S2120).

In one embodiment, the encoding apparatus may perform various intra prediction modes on the current block to derive an intra prediction mode with an optimal rate-distortion (RD) cost and determine this as the intra prediction mode of the current block. For example, the encoding apparatus may derive the optimal intra prediction mode for the current block based on intra prediction modes including 2 non-directional intra prediction modes and 65 intra directional prediction modes.

And, the encoding apparatus may determine whether the optimal intra prediction mode derived for the current block is one of the candidate intra prediction modes in the MPM list, and generate the intra prediction mode information for the current block according to the determination result. For example, if an intra prediction mode for the current block is included among the candidate intra prediction modes in the MPM list, the encoding apparatus may generate the value of the MPM flag information as 1 and generate the intra prediction mode information (e.g., MPM index information) indicating the intra prediction mode for the current block among candidate intra prediction modes in the MPM list. Alternatively, if the intra prediction mode for the current block is not included among the candidate intra prediction modes in the MPM list, the encoding apparatus may generate the value of the MPM flag information as 0 and generate remaining mode information indicating the intra prediction mode for the current block among the remaining intra prediction modes excluding the candidate intra prediction modes in the MPM list.

As a more specific example, a primary MPM list and a secondary MPM list may be constructed for the current block. In addition, the MPM list may correspond to the primary MPM list or the secondary MPM list. In this case, the encoding apparatus may generate primary MPM flag information and secondary MPM flag information for indicating whether the intra prediction mode for the current block is derived based on the candidate intra prediction modes.

For example, the intra prediction mode information may be generated based on the value of the primary MPM flag information being 1 or the value of the secondary MPM flag information being 1. In this case, the intra prediction mode information may include at least one of non-planar flag information, MPM index information, second non-planar flag information, or second MPM index information.

Alternatively, for example, based on the value of the primary MPM flag information being 0, the secondary MPM flag information may be configured to be parsed. In addition, the intra prediction mode information may be generated based on the value of the secondary MPM flag information being 1. In this case, the intra prediction mode information may include at least one of second non-planar flag information or second MPM index information.

Alternatively, for example, based on the value of the primary MPM flag information being 0, the secondary MPM flag information may be configured to be parsed, and the intra prediction mode information may be generated based on the value of the secondary MPM flag information being 0. In this case, the intra prediction mode information may include remaining mode information.

The encoding apparatus may generate a bitstream by encoding image information including the intra prediction mode information (S2130).

In one embodiment, the encoding apparatus may encode the image information including the intra prediction mode information (e.g., the MPM index information, the remaining mode information, the MPM flag information, etc.) of the current block derived based on the MPM list as described above, and generate it as the bitstream.

As a specific example, when the MPM list is composed of at least one of the primary MPM list and the secondary MPM list, the encoding apparatus may encode the image information including the primary MPM flag information, the secondary MPM flag information, the MPM index information, the second MPM index information, the non-planar flag information, and the second non-planar flag information, and generate it as the bitstream.

In addition, according to the embodiment, the encoding apparatus may generate the prediction samples of the current block based on the intra prediction mode of the current block. In one embodiment, the encoding apparatus may derive at least one neighboring reference sample among neighboring reference samples of the current block based on the intra prediction mode and generate the prediction samples based on the neighboring reference sample.

In addition, the encoding apparatus may derive the residual samples for the current block based on the prediction samples of the current block and the original samples of the current block. And, the encoding apparatus may generate residual information for the current block based on the residual samples and encode image information including the residual information. Here, the residual information may include information such as value information, position information, transform technique, transform kernel, and a quantization parameter of quantized transform coefficients derived by performing transform and quantization on the residual samples.

That is, the encoding apparatus may output the bitstream by encoding the image information including the intra prediction mode information and/or the residual information of the current block described above.

The bitstream may be transmitted to the decoding apparatus via a network or (digital) storage medium. Here, the network may include a broadcasting network and/or a communication network, and the digital storage medium may include various storage media such as USB, SD, CD, DVD, Blu-ray, HDD, and SSD.

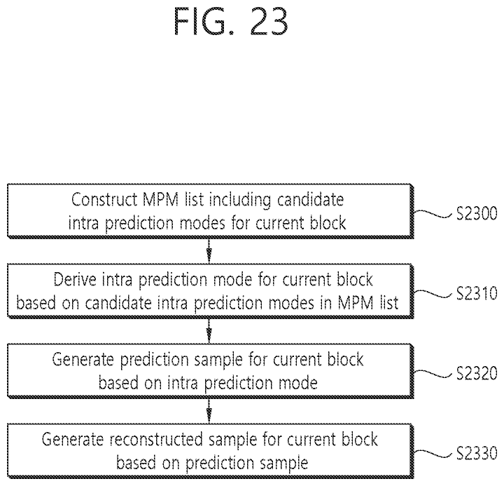

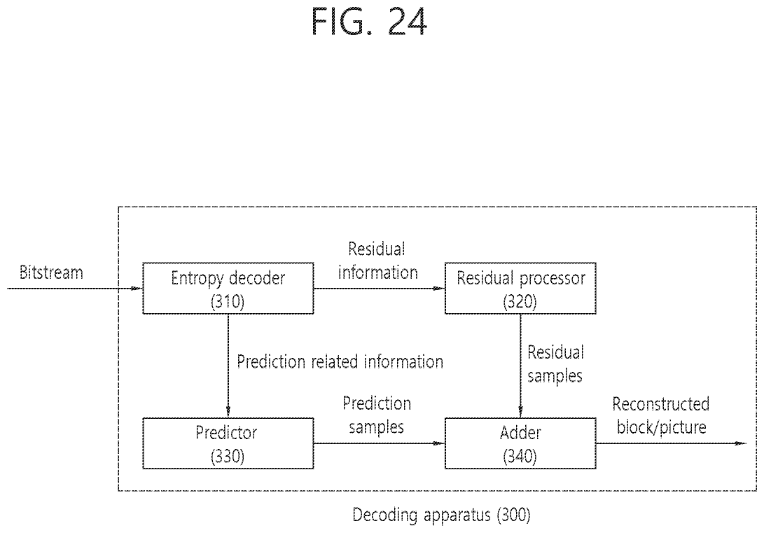

FIGS. 23 and 24 schematically show an example of a video/image decoding method and related components according to the embodiment(s) of the present disclosure.

The method disclosed in FIG. 23 may be performed by the decoding apparatus disclosed in FIG. 3 or FIG. 24. Specifically, steps S2300 to S2320 of FIG. 23 may be performed by the predictor 330 of the decoding apparatus, and step S2330 of FIG. 23 may be performed by the adder 340 of the decoding apparatus. In addition, although not shown in FIG. 23, the entropy decoder 310 of the decoding apparatus may obtain/parse various information necessary for image reconstruction, and the residual processor 320 of the decoding apparatus may derive residual samples. In addition, the method disclosed in FIG. 23 may be performed including the embodiments described above in the present disclosure. Therefore, in FIG. 23, detailed descriptions of content that overlaps with the above-described embodiments will be omitted or simplified.

Referring to FIG. 23, the decoding apparatus may construct a Most Probable Mode (MPM) list including candidate intra prediction modes for a current block (S2300). That is, the decoding apparatus may construct the MPM list for the current block according to the above-described embodiment(s).

For example, the MPM list may include at least one of a primary MPM list or a secondary MPM list. The primary MPM list may include 6 candidate intra prediction modes, and the secondary MPM list may include 16 candidate intra prediction modes.

In one embodiment, when constructing the MPM list, the decoding apparatus may construct a specific intra prediction mode as one of the candidate intra prediction modes of the MPM list. For example, the specific intra prediction mode may include at least one of an intra prediction mode derived based on a Template-based Intra Mode Derivation (TIMD) mode or an intra prediction mode derived based on a Decoder Side Intra Mode Derivation (DIMD) mode.

Here, the intra prediction mode derived based on the TIMD mode may be derived based on the template of the current block as described above, and may be an intra prediction mode derived based on the SATD (Sum of Absolute Transformed Difference) between the prediction sample of the template and the reconstructed sample of the template. The intra prediction mode derived based on the DIMD mode may be an intra prediction mode derived based on a histogram of gradients (HoG) from the neighboring reconstructed samples of the current block, as described above.

For example, the decoding apparatus may derive the neighboring angular mode of the intra prediction mode derived based on the TIMD mode based on the number of candidate intra prediction modes in the MPM list and construct it as one of the candidate intra prediction modes in the MPM list. Here, the neighboring angular mode of the intra prediction mode derived based on the TIMD mode may be derived as in the embodiment of FIG. 16 described above. In other words, if the MPM list is not filled with the predetermined number of candidates, the neighboring angular mode of the intra prediction mode derived based on the TIMD mode may be derived and constructed as one of the candidate intra prediction modes in the MPM list. At this time, in the case of a primary MPM list, the predetermined number of candidates may be 6, or in the case of a secondary MPM list, the predetermined number of candidates may be 16.

In addition, the decoding apparatus may add the intra prediction mode derived based on the TIMD mode and the neighboring angular mode of the intra prediction mode derived based on the TIMD mode into the MPM list in a preset order.

For example, the decoding apparatus may first derive candidate intra prediction modes including at least one of a first candidate intra prediction mode derived from a left neighboring block of the current block and a second candidate intra prediction mode derived from an upper neighboring block of the current block, and may add them to the MPM list. And, based on the number of candidate intra prediction modes in the MPM list, the decoding apparatus may add the intra prediction mode derived based on the TIMD mode after the first candidate intra prediction mode and the second candidate intra prediction mode to the MPM list.

In addition, for example, the decoding apparatus may derive candidate intra prediction modes including at least one of a first angular mode derived based on the first candidate intra prediction mode or a second angular mode derived based on the second candidate intra prediction mode, and add them to the MPM list. Here, the first angular mode and the second angular mode may be derived as in the embodiment of FIG. 16 described above. And then, based on the number of candidate intra prediction modes in the MPM list, the decoding apparatus may add the neighboring angular mode of the intra prediction mode derived based on the TIMD mode to the MPM list after the first angular mode and the second angular mode.

In addition, as another example, based on the number of candidate intra prediction modes in the MPM list, the decoding apparatus may add the neighboring angular mode of the intra prediction mode derived based on the TIMD mode to the MPM list before the first angular mode and the second angular mode.

The MPM list may include at least one of a primary MPM list or a secondary MPM list. In this case, the intra prediction mode derived based on the TIMD mode and the neighboring angular mode of the intra prediction mode derived based on the TIMD mode may be included in one of the primary MPM list or the secondary MPM list.

For example, when constructing candidates in the primary MPM list, if the primary MPM list is not filled with 6 candidate intra prediction modes, the intra prediction mode derived based on the TIMD mode and the neighboring angular mode of the intra prediction mode derived based on the TIMD mode may be added to the primary MPM list.

Alternatively, for example, when constructing candidates in the secondary MPM list, if the secondary MPM list is not filled with 16 candidate intra prediction modes, the intra prediction mode derived based on the TIMD mode and the neighboring angular mode of the intra prediction mode derived based on the TIMD mode may be added to the secondary MPM list.

Meanwhile, as an example, the decoding apparatus may derive the neighboring angular mode of the intra prediction mode derived based on the DIMD mode based on the number of candidate intra prediction modes in the MPM list and construct it as one of the candidate intra prediction modes in the MPM list. Here, the neighboring angular mode of the intra prediction mode derived based on the DIMD mode may be derived as in the embodiment of FIG. 16 described above. In other words, if the MPM list is not filled with the predetermined number of candidates, the neighboring angular mode of the intra prediction mode derived based on the DIMD mode may be derived and constructed as one of the candidate intra prediction modes in the MPM list. At this time, in the case of the primary MPM list, the predetermined number of candidates may be 6, or in the case of the secondary MPM list, the predetermined number of candidates may be 16.

In addition, the decoding apparatus may add the intra prediction mode derived based on the DIMD mode and the neighboring angular mode of the intra prediction mode derived based on the DIMD mode into the MPM list according to a preset order.

For example, the decoding apparatus may first derive candidate intra prediction modes including at least one of a first candidate intra prediction mode derived from a left neighboring block of the current block and a second candidate intra prediction mode derived from an upper neighboring block of the current block, and add them to the MPM list. And, based on the number of candidate intra prediction modes in the MPM list, the decoding apparatus may add the intra prediction mode derived based on the DIMD mode after the first candidate intra prediction mode and the second candidate intra prediction mode to the MPM list.

In addition, for example, the decoding apparatus may derive candidate intra prediction modes including at least one of a first angular mode derived based on the first candidate intra prediction mode or a second angular mode derived based on the second candidate intra prediction mode, and add them to the MPM list. Here, the first angular mode and the second angular mode may be derived as in the embodiment of FIG. 16 described above. And then, based on the number of candidate intra prediction modes in the MPM list, the decoding apparatus may add the neighboring angular mode of the intra prediction mode derived based on the DIMD mode to the MPM list after the first angular mode and the second angular mode.

In addition, as another example, based on the number of candidate intra prediction modes in the MPM list, the decoding apparatus may add the neighboring angular mode of the intra prediction mode derived based on the DIMD mode to the MPM list before the first angular mode and the second angular mode.

The MPM list may include at least one of a primary MPM list or a secondary MPM list. In this case, the intra prediction mode derived based on the DIMD mode and the neighboring angular mode of the intra prediction mode derived based on the DIMD mode may be included in one of the primary MPM list or the secondary MPM list.

For example, when constructing candidates in the primary MPM list, if the primary MPM list is not filled with 6 candidate intra prediction modes, the intra prediction mode derived based on the DIMD mode and the neighboring angular mode of the intra prediction mode derived based on the DIMD mode may be added to the primary MPM list.

Alternatively, for example, when constructing candidates in the secondary MPM list, if the secondary MPM list is not filled with 16 candidate intra prediction modes, the intra prediction mode derived based on the DIMD mode and the neighboring angular mode of the intra prediction mode derived based on the DIMD mode may be added to the secondary MPM list.

The decoding apparatus may derive an intra prediction mode for the current block based on the candidate intra prediction modes in the MPM list (S2310).

In one embodiment, the decoding apparatus may obtain the intra prediction mode information for the current block from the bitstream. The intra prediction mode information is information to indicate the intra prediction mode of the current block and may include MPM flag information, MPM index information, remaining mode information, etc.

The decoding apparatus may obtain the MPM flag information indicating whether the intra prediction mode for the current block is included among the candidate intra prediction modes in the MPM list. And, the decoding apparatus may obtain the MPM index information or the remaining mode information based on the MPM flag information.

For example, if the intra prediction mode for the current block is included among the candidate intra prediction modes in the MPM list (i.e., when the MPM flag information indicates 1), the decoding apparatus may obtain the MPM index information indicating the intra prediction mode for the current block among the candidate intra prediction modes in the MPM list, and derive the candidate intra prediction mode indicated by the MPM index information in the MPM list as the intra prediction mode of the current block.

Alternatively, if the intra prediction mode for the current block is not included among the candidate intra prediction modes in the MPM list (i.e., when the MPM flag information indicates 0), the decoding apparatus may obtain the remaining mode information indicating the intra prediction mode for the current block among the remaining intra prediction modes excluding the candidate intra prediction modes in the MPM list. And, the intra prediction mode indicated by the remaining mode information may be derived as the intra prediction mode for the current block.

As a more specific example, the primary MPM list and the secondary MPM list may be constructed for the current block. In addition, the MPM list may correspond to the primary MPM list or the secondary MPM list. In this case, the intra prediction mode for the current block may be derived based on primary MPM flag information or secondary MPM flag information.

For example, based on the value of the primary MPM flag information being 1 or the value of the secondary MPM flag information being 1, the intra prediction mode may be derived based on the intra prediction mode information. In this case, the intra prediction mode information may include at least one of non-planar flag information, MPM index information, second non-planar flag information, or second MPM index information.

In addition, for example, the secondary MPM flag information may be parsed based on the value of primary MPM flag information being 0. In addition, based on the value of the secondary MPM flag information being 1, the intra prediction mode may be derived based on the intra prediction mode information. In this case, the intra prediction mode information may include at least one of second non-planar flag information or second MPM index information.

Alternatively, for example, based on the value of the primary MPM flag information being 0, the secondary MPM flag information may be parsed, and the value of the secondary MPM flag information may be 0. In addition, based on the value of the secondary MPM flag information being 0, the intra prediction mode may be derived based on intra prediction mode information. In this case, the intra prediction mode information may include remaining mode information.

The decoding apparatus may generate a prediction sample for the current block based on the intra prediction mode (S2320).

In one embodiment, the decoding apparatus may derive at least one neighboring sample among neighboring samples of the current block based on the intra prediction mode, and generate prediction samples based on the neighboring sample.

The decoding apparatus may generate a reconstructed sample for the current block based on the prediction samples ($2330).

In one embodiment, the decoding apparatus may directly use prediction samples as reconstructed samples depending on the prediction mode, or may generate reconstructed samples by adding residual samples to prediction samples.

If the residual sample for the current block exists, the decoding apparatus may receive information about the residual for the current block. The information about the residual may include transformation coefficients about the residual samples. The decoding apparatus may derive the residual samples (or residual sample array) for the current block based on the residual information. Specifically, the decoding apparatus may derive quantized transform coefficients based on the residual information. The quantized transform coefficients may have a one-dimensional vector form based on the coefficient scan order. The decoding apparatus may derive transform coefficients based on a dequantization process for the quantized transform coefficients. The decoding apparatus may derive the residual samples based on the transform coefficients.

The decoding apparatus may generate the reconstructed samples based on the prediction samples and the residual samples, and may derive a reconstructed block or reconstructed picture based on the reconstructed samples. Thereafter, as described above, the decoding apparatus may apply an in-loop filtering procedure, such as deblocking filtering and/or SAO procedure, to the reconstructed picture in order to improve subjective/objective picture quality, if necessary.

According to the embodiment(s) of the present disclosure described above, unlike the existing method of constructing an MPM list considering only the intra prediction mode of the neighboring decoded block, an MPM list may be constructed by calculating template costs of intra prediction modes using neighboring decoded samples and giving high priority to prediction modes with low template costs. Accordingly, the amount of data (e.g. MPM index bit/Secondary MPM index bit) required for intra prediction mode signaling may be reduced based on the MPM list (primary MPM list) and/or secondary MPM list, and intra prediction may be performed efficiently.

In addition, according to the embodiment(s) of the present disclosure described above, by calculating the template costs for the intra prediction modes that construct the MPM list (primary MPM list and/or secondary MPM list) and using the intra prediction mode derived based on this (e.g. TIMD or template-based DIMD mode), a more efficient order of candidate modes in the MPM list (primary MPM list and/or secondary MPM list) may be provided.

In addition, according to the embodiment(s) of the present disclosure described above, an MPM list (primary MPM list and/or secondary MPM list) may be effectively constructed by giving priority to the intra mode derived from the template-based decoder side (e.g., TIMD or template-based DIMD mode) and a mode similar to the intra mode (i.e., neighboring angular mode). Accordingly, the amount of bits transmitted in the bitstream may be reduced to derive the intra prediction mode for the current block, and further, compression efficiency may be improved.

In the above-described embodiment, the methods are described based on the flowchart having a series of steps or blocks. The embodiments of the present disclosure are not limited to the order of the above steps or blocks. Some steps or blocks may occur simultaneously or in a different order from other steps or blocks as described above. Further, those skilled in the art will understand that the steps shown in the above flowchart are not exclusive, that further steps may be included, or that one or more steps in the flowchart may be deleted without affecting the scope of the present disclosure.

The above-described method according to the embodiments of the present disclosure may be implemented in the form of software, and the encoding apparatus and/or decoding apparatus according to the present disclosure may be included in devices that perform image processing, such as a TV, computer, smartphone, set-top box, display device.

When the embodiments in the present disclosure are implemented as software, the above-described method may be implemented as a module (process, function, etc.) that performs the above-described functions. The module may be stored in memory and executed by a processor. The memory may be internal or external to the processor, and may be coupled with the processor in a variety of well-known means. The processor may include an application-specific integrated circuit (ASIC), other chipsets, logic circuits, and/or data processing devices. The memory may include read-only memory (ROM), random access memory (RAM), flash memory, memory cards, storage media, and/or other storage devices. That is, the embodiments described in the present disclosure may be implemented and performed on a processor, microprocessor, controller, or chip. For example, functional units shown in each drawing may be implemented and performed on a computer, processor, microprocessor, controller, or chip. In this case, information for implementation (e.g., information on instructions) or an algorithm may be stored in a digital storage medium.

In addition, the decoding apparatus and the encoding apparatus to which the embodiment(s) of the present disclosure are applied may be included in a multimedia broadcasting transmission/reception apparatus, a mobile communication terminal, a home cinema video apparatus, a digital cinema video apparatus, a surveillance camera, a video chatting apparatus, a real-time communication apparatus such as video communication, a mobile streaming apparatus, a storage medium, a camcorder, a VOD service providing apparatus, an Over the top (OTT) video apparatus, an Internet streaming service providing apparatus, a three-dimensional (3D) video apparatus, a virtual reality (VR) apparatus, an augmented reality (AR) apparatus, a teleconference video apparatus, a transportation user equipment (e.g., vehicle (including autonomous vehicles) user equipment, an airplane user equipment, a ship user equipment, etc.) and a medical video apparatus and may be used to process video signals and data signals. For example, the Over the top (OTT) video apparatus may include a game console, a blue-ray player, an internet access TV, a home theater system, a smart phone, a tablet PC, a Digital Video Recorder (DVR), and the like.

Furthermore, the processing method to which the embodiment(s) of the present disclosure is applied may be produced in the form of a program that is to be executed by a computer and may be stored in a computer-readable recording medium. Multimedia data having a data structure according to the embodiment(s) of the present disclosure may also be stored in computer-readable recording media. The computer-readable recording media include all types of storage devices and distributed storage devices in which data readable by a computer system is stored. The computer-readable recording media may include, for example, a Blu-ray Disk (BD), a Universal Serial Bus (USB), ROM, PROM, EPROM, EEPROM, RAM, CD-ROM, a magnetic tape, a floppy disk, and an optical data storage device. Furthermore, the computer-readable recording media includes media implemented in the form of carrier waves (e.g., transmission through the Internet). In addition, a bitstream generated by the encoding method may be stored in a computer-readable recording medium or may be transmitted over wired/wireless communication networks.

In addition, the embodiment(s) of the present disclosure may be implemented with a computer program product according to program codes, and the program codes may be performed in a computer by the embodiment(s) of the present disclosure. The program codes may be stored on a carrier which is readable by a computer.

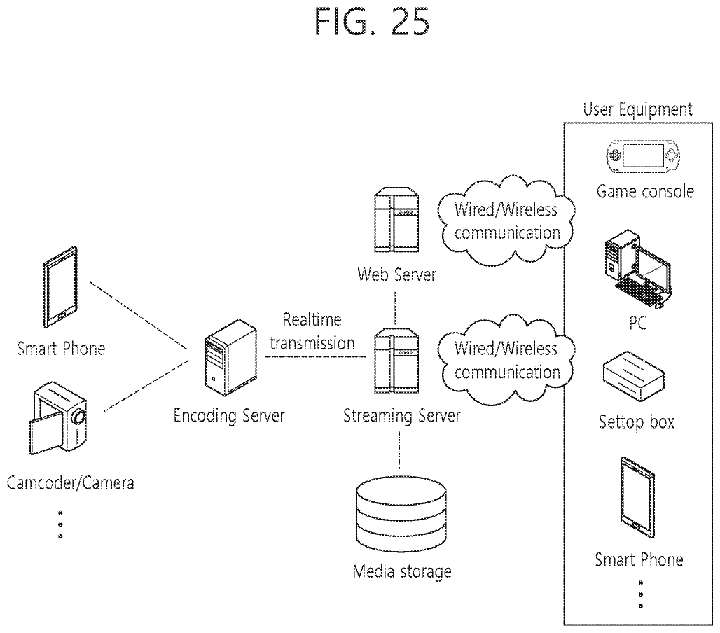

FIG. 25 illustrates an example of a content streaming system to which embodiments disclosed in the present disclosure may be applied.

Referring to FIG. 25, the content streaming system to which the embodiments of the present document are applied may basically include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmit the bitstream to the streaming server. As another example, when the multimedia input devices such as smartphones, cameras, camcorders, etc. directly generate a bitstream, the encoding server may be omitted.

The bitstream may be generated by an encoding method or a bitstream generating method to which the embodiment(s) of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of what services are available. When the user requests a desired service from the web server, the web server delivers it to a streaming server, and the streaming server transmits multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., Smartwatches, smart glasses, head mounted displays), digital TVs, desktops computer, digital signage, and the like.

Each server in the content streaming system may be operated as a distributed server, in which case data received from each server may be distributed.

The claims described in the present disclosure may be combined in various ways. For example, the technical features of the method claims of the present disclosure may be combined to be implemented as an apparatus, and the technical features of the apparatus claims of the present disclosure may be combined to be implemented as a method. In addition, the technical features of the method claim of the present disclosure and the technical features of the apparatus claim of the present disclosure may be combined to be implemented as an apparatus, and the technical features of the method claim of the present disclosure and the technical features of the apparatus claim of the present disclosure may be combined to be implemented as a method.

What is claimed is:

1. An image decoding method performed by a decoding apparatus, the method comprising:
constructing a Most Probable Mode (MPM) list including candidate intra prediction modes for a current block;
deriving an intra prediction mode for the current block based on the candidate intra prediction modes in the MPM list;
generating a prediction sample for the current block based on the intra prediction mode; and
generating a reconstructed sample for the current block based on the prediction sample,
wherein a specific intra prediction mode is constructed as one of the candidate intra prediction modes in the MPM list,
wherein the specific intra prediction mode includes at least one of an intra prediction mode derived based on a Template-based Intra Mode Derivation (TIMD) mode or an intra prediction mode derived based on a Decoder Side Intra Mode Derivation (DIMD) mode.

2. The image decoding method of claim 1, wherein based on a number of the candidate intra prediction modes in the MPM list, a neighboring angular mode of the intra prediction mode derived based on the TIMD mode is derived and constructed as one of the candidate intra prediction modes in the MPM list.

3. The image decoding method of claim 2, wherein the intra prediction mode derived based on the TIMD mode and the neighboring angular mode of the intra prediction mode derived based on the TIMD mode are added to the MPM list according to a predetermined order.

4. The image decoding method of claim 1, wherein based on a number of the candidate intra prediction modes in the MPM list, a neighboring angular mode of the intra prediction mode derived based on the DIMD mode is derived and constructed as one of the candidate intra prediction modes in the MPM list.

5. The image decoding method of claim 4, wherein the intra prediction mode derived based on the DIMD mode and the neighboring angular mode of the intra prediction mode derived based on the DIMD mode are added to the MPM list according to a predetermined order.

6. The image decoding method of claim 2, wherein the candidate intra prediction modes in the MPM list include at least one of a first candidate intra prediction mode derived from a left neighboring block of the current block or a second candidate intra prediction mode derived from an upper neighboring block of the current block,
wherein the intra prediction mode derived based on the TIMD mode is added to the MPM list after the first candidate intra prediction mode and the second candidate intra prediction mode, based on the number of the candidate intra prediction modes in the MPM list.

7. The image decoding method of claim 6, wherein the candidate intra prediction modes in the MPM list include a first angular mode derived based on the first candidate intra prediction mode or a second angular mode derived based on the second candidate intra prediction mode, wherein the neighboring angular mode of the intra prediction mode derived based on the TIMD mode is added to the MPM list after the first angular mode and the second angular mode, based on the number of the candidate intra prediction modes in the MPM list.

8. The image decoding method of claim 6, wherein the candidate intra prediction modes in the MPM list include a first angular mode derived based on the first candidate intra prediction mode or a second angular mode derived based on the second candidate intra prediction mode,
wherein the neighboring angular mode of the intra prediction mode derived based on the TIMD mode is added to the MPM list before the first angular mode and the second angular mode, based on the number of the candidate intra prediction modes in the MPM list.

9. The image decoding method of claim 4, wherein the candidate intra prediction modes in the MPM list include at least one of a first candidate intra prediction mode derived from a left neighboring block of the current block or a second candidate intra prediction mode derived from an upper neighboring block of the current block,
wherein the intra prediction mode derived based on the DIMD mode is added to the MPM list after the first candidate intra prediction mode and the second candidate intra prediction mode, based on the number of candidate intra prediction modes in the MPM list.

10. The image decoding method of claim 9, wherein the candidate intra prediction modes in the MPM list include a first angular mode derived based on the first candidate intra prediction mode or a second angular mode derived based on the second candidate intra prediction mode,
wherein the neighboring angular mode of the intra prediction mode derived based on the DIMD mode is added to the MPM list after the first angular mode and the second angular mode, based on the number of the candidate intra prediction modes in the MPM list.

11. The image decoding method of claim 9, wherein the candidate intra prediction modes in the MPM list include a first angular mode derived based on the first candidate intra prediction mode or a second angular mode derived based on the second candidate intra prediction mode,
wherein the neighboring angular mode of the intra prediction mode derived based on the DIMD mode is added to the MPM list before the first angular mode and the second angular mode, based on the number of the candidate intra prediction modes in the MPM list.

12. The image decoding method of claim 1, wherein the intra prediction mode derived based on the TIMD mode is derived based on a template of the current block, and is an intra prediction mode derived based on a Sum of Absolute Transformed Difference (SATD) between a prediction sample of the template and a reconstructed sample of the template.

13. The image decoding method of claim 1, wherein the intra prediction mode derived based on the DIMD mode is an intra prediction mode derived based on Histogram of gradients (HoG) from a neighboring reconstructed sample of the current block.

14. The image decoding method of claim 2, wherein the MPM list includes at least one of a primary MPM list or a secondary MPM list,
wherein the intra prediction mode derived based on the TIMD mode and the neighboring angular mode of the intra prediction mode derived based on the TIMD mode are included in one of the primary MPM list or the secondary MPM list.

15. The image decoding method of claim 4, wherein the MPM list includes at least one of a primary MPM list or a secondary MPM list,
wherein the intra prediction mode derived based on the DIMD mode and the neighboring angular mode of the intra prediction mode derived based on the DIMD mode are included in one of the primary MPM list or the secondary MPM list.

16. The image decoding method of claim 14, wherein the primary MPM list includes 6 candidate intra prediction modes,
wherein the secondary MPM list includes 16 candidate intra prediction modes.

17. An image encoding method performed by a encoding apparatus, the method comprising:
constructing a Most Probable Mode (MPM) list including candidate intra prediction modes for a current block;
deriving an intra prediction mode for the current block based on the candidate intra prediction modes in the MPM list;
generating intra prediction mode information for the current block based on the intra prediction mode; and
generating a bitstream by encoding image information including the intra prediction mode information,
wherein a specific intra prediction mode is constructed as one of the candidate intra prediction modes in the MPM list,
wherein the specific intra prediction mode includes at least one of an intra prediction mode derived based on a Template-based Intra Mode Derivation (TIMD) mode or an intra prediction mode derived based on a Decoder Side Intra Mode Derivation (DIMD) mode.

18. A computer-readable digital storage medium storing a bitstream generated by the image encoding method of claim 17.

19. A transmission method of data for image, the method comprising:
obtaining a bitstream of the image, wherein the bitstream is generated based on constructing a Most Probable Mode (MPM) list including candidate intra prediction modes for a current block, deriving an intra prediction mode for the current block based on the candidate intra prediction modes in the MPM list, generating intra prediction mode information for the current block based on the intra prediction mode, and generating a bitstream by encoding image information including the intra prediction mode information; and
transmitting the data comprising the bitstream,
wherein a specific intra prediction mode is constructed as one of the candidate intra prediction modes in the MPM list,
wherein the specific intra prediction mode includes at least one of an intra prediction mode derived based on a Template-based Intra Mode Derivation (TIMD) mode or an intra prediction mode derived based on a Decoder Side Intra Mode Derivation (DIMD) mode.
